(19) United States
(12) Patent Application Publication
(10) Pub. No.: US 2023/0222742 A1
(43) Pub. Date: Jul. 13, 2023

(54) INFORMATION PROCESSING APPARATUS, INFORMATION PROCESSING METHOD, AND INFORMATION PROCESSING PROGRAM

(71) Applicant: SONY GROUP CORPORATION, Tokyo (JP)

(72) Inventors: Shinichi KAWANO, Tokyo (JP); Tsuyoshi ISHIKAWA, Kanagawa (JP); Jun KIMURA, Kanagawa (JP); Ikuo YAMANO, Tokyo (JP); Keijiroh NAGANO, Tokyo (JP)

(73) Assignee: SONY GROUP CORPORATION, Tokyo (JP)

(21) Appl. No.: 18/009,164

(22) PCT Filed: Jul. 2, 2021
(86) PCT No.: PCT/JP2021/025121

§ 371 Date: Dec. 8, 2022

(30) Foreign Application Priority Data
Jul. 21, 2020 (JP) 2020-124150

(51) Int. Cl. G06T 19/00; G06F 3/01; G06T 7/70

(52) U.S. Cl. CPC G06T 19/006; G06F 3/014; G06F 3/017; G06T 7/70

(57) ABSTRACT

An information processing apparatus includes a display unit (331) and a control unit (350). The display unit (331) displays a virtual operation object to be superimposed on a reality space visually recognized by a user. The control unit (350) determines a superimposition target object on which the operation object is to be superimposed from among a plurality of objects existing around the user in the reality space, detects a movement of a hand of the user in a state where the operation object is displayed, and presents the operation object to the user while moving the operation object to approach the superimposition target object in conjunction with the detected movement of the hand of the user.

### FIELD

The present disclosure relates to an information processing apparatus, an information processing method, and an information processing program.

### BACKGROUND

Conventionally, devices, systems, and the like to which augmented reality (AR) technology (also referred to as “augmented reality”) is applied have been developed. The AR technology is a technology for expanding a reality space viewed from a user by displaying a virtual object superimposed on an object existing in the reality space. For example, Patent Literature 1 proposes a technique for displaying a virtual object in a superimposed state in accordance with a shape of an object existing in a reality space.

### CITATION LIST

### Patent Literature

Patent Literature 1: WO 2016/203792 A

### SUMMARY

### Technical Problem

However, in the AR technology, there has always been a demand for improving usability during operating a virtual object so that a sense of immersion is not impaired in the expanded space.

Therefore, the present disclosure proposes an information processing apparatus, an information processing method, and an information processing program capable of improving usability.

### Solution to Problem

To solve the above problem, an information processing apparatus that provides a service that requires an identity verification process according to an embodiment of the present disclosure includes: a display unit that displays a virtual operation object to be superimposed on a reality space visually recognized by a user; and a control unit that determines a superimposition target object on which the operation object is to be superimposed from among a plurality of objects existing around the user in the reality space, detects a movement of a hand of the user in a state where the operation object is displayed, and presents the operation object to the user while moving the operation object to approach the superimposition target object in conjunction with the detected movement of the hand of the user.

### BRIEF DESCRIPTION OF DRAWINGS

FIG. 1 is a diagram illustrating an example of a configuration of an AR glasses system according to an embodiment of the present disclosure.

FIG. 2 is a schematic view schematically illustrating an appearance of AR glasses according to the embodiment of the present disclosure.

FIG. 3 is a block diagram illustrating an example of a functional configuration of a hand sensor according to the embodiment of the present disclosure.

FIG. 4 is a block diagram illustrating an example of a functional configuration of the AR glasses according to the embodiment of the present disclosure.

FIG. 5 is a diagram illustrating an outline of grippability determination information according to the embodiment of the present disclosure.

FIG. 6 is a diagram illustrating an outline of superimposition determination information according to the embodiment of the present disclosure.

FIG. 7 is a diagram illustrating an outline of determining whether a recognition object is grippable according to the embodiment of the present disclosure.

FIG. 8 is a diagram illustrating an example of registration of mark information according to the embodiment of the present disclosure.

FIG. 9 is a diagram illustrating an outline of determining an operation start action according to the embodiment of the present disclosure.

FIG. 10 is a diagram illustrating an outline of determining a superimposition target object according to the embodiment of the present disclosure.

FIG. 11 is a diagram illustrating an outline of determining an operation start action according to the embodiment of the present disclosure.

FIG. 12 is a diagram illustrating an outline of moving a virtual operation object according to the embodiment of the present disclosure.

FIG. 13 is a diagram illustrating an example in which the virtual operation object is displayed in a superimposed state according to the embodiment of the present disclosure.

FIG. 14 is a flowchart illustrating an example of a processing procedure for determining grippability according to the embodiment of the present disclosure.

FIG. 15 is a flowchart illustrating an example of a processing procedure for determining an operation start action according to the embodiment of the present disclosure.

FIG. 16 is a flowchart illustrating an example of a processing procedure for determining a superimposition target object according to the embodiment of the present disclosure.

FIG. 17 is a flowchart illustrating an example of a processing procedure for determining a layout of the virtual operation object according to the embodiment of the present disclosure.

FIG. 18 is a flowchart illustrating an example of a processing procedure for determining a layout of the virtual operation object according to the embodiment of the present disclosure.

FIG. 19 is a diagram illustrating an example in which the layout of the virtual operation object is changed according to a modification.

FIG. 20 is a diagram illustrating an example in which a tactile stimulus is provided in a case where the virtual operation object is moved according to a modification.

FIG. 21 is a diagram illustrating an example of a configuration of an AR glasses system according to a modification.

FIG. 22 is a block diagram illustrating an example of a functional configuration of a server device according to a modification.

FIG. 23 is a block diagram illustrating an example of a hardware configuration of the hand sensor.

FIG. 24 is a block diagram illustrating an example of a hardware configuration of the AR glasses.

### DESCRIPTION OF EMBODIMENTS

Hereinafter, embodiments of the present disclosure will be described in detail with reference to the drawings. Note that, in the following embodiments, the same parts will be denoted by the same reference numerals or signs, and overlapping description may be omitted. In addition, in the present specification and the drawings, a plurality of components having substantially the same functional configuration may be distinguished from each other by attaching different numerals and signs after the same reference numeral or sign.

In addition, the present disclosure will be described according to the following order of items.
1. Outline of Present Disclosure
2. Example of Configuration of System
3. Example of Configuration of Device
3-1. Configuration of Hand Sensor
3-2. Configuration of AR Glasses
4. Example of Processing Procedure
4-1. Processing of Determination of Grippability
4-2. Processing of Determination of Operation Start Action
4-3. Processing of Determination of Superimposition Target Object
4-4. Processing of Determination of Layout of Virtual Operation Object
4-5. Processing of Movement of Virtual Operation Object
5. Modifications
5-1. Concerning Superimposition Target Object
5-2. Concerning Layout of Virtual Operation Object
5-3. Provision of Tactile Stimulus in Case Where Virtual Operation Object Is Moved
5-4. Change of System Configuration
5-5. Other Modifications
6. Example of Hardware Configuration
6-1. Concerning Hand Sensor
6-2. Concerning AR Glasses
7. Conclusion

### 1. Outline of Present Disclosure

An outline of a technology according to the present disclosure will be described. The present disclosure relates to an AR technology. In the present disclosure, AR glasses, one of wearable devices to be worn on a head of a user, are used as an example of an information processing apparatus.

The AR glasses of the present disclosure have a display unit and a control unit as some of the feasible functions. The display unit displays a virtual object to be operated (hereinafter referred to as a “virtual operation object”) to be superimposed on a reality space visually recognized by the user. The control unit determines a superimposition target object on which the virtual operation object is to be superimposed from among a plurality of objects existing around the user in the reality space, detects a movement of a hand of the user in a state where the virtual operation object is displayed, and presents the virtual operation object to the user while moving the virtual operation object to approach the superimposition target object in conjunction with the detected movement of the hand of the user.

The AR glasses of the present disclosure present the virtual operation object to the user while moving the virtual operation object to approach the superimposition target object in conjunction with a movement of the hand of the user. This makes it possible to improve usability during operating the virtual operation object.

### 2. Example of Configuration of System

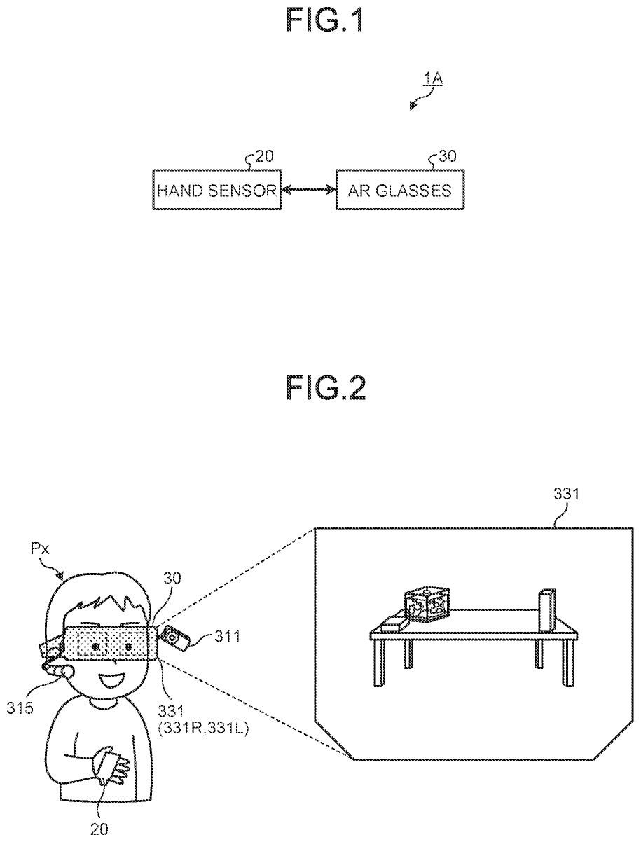

Hereinafter, an AR glasses system 1A according to an embodiment of the present disclosure will be described. FIG. 1 is a diagram illustrating an example of a configuration of an AR glasses system according to an embodiment of the present disclosure.

As illustrated in FIG. 1, the AR glasses system 1A includes a hand sensor 20 and AR glasses 30. The hand sensor 20 is worn on a hand of a user. The hand sensor 20 can detect a posture, position, and movement of the hand of the user. The AR glasses 30 are a glasses-type wearable device to be worn on a head of the user. The AR glasses 30 can display a virtual operation object superimposed on a reality space (hereinafter, appropriately referred to as a “real space”). The hand sensor 20 is communicably connected to the AR glasses 30 through a communication means for performing wireless communication or wired communication. The hand sensor 20 transmits a result (information) of detecting the posture, position, and movement of the hand of the user wearing the hand sensor 20 to the AR glasses 30. In addition, the AR glasses 30 can transmit a control command and the like to the hand sensor 20 through the communication means for communication with the hand sensor 20. Furthermore, the AR glasses 30 execute various types of processing on the basis of the result (information) of detecting the posture, position, and movement of the hand received from the hand sensor 20.

An appearance of the AR glasses 30 will be described with reference to FIG. 2. FIG. 2 is a schematic view schematically illustrating an appearance of the AR glasses according to the embodiment of the present disclosure. As illustrated in FIG. 2, the AR glasses 30 are a glasses-type or goggle-type device to be worn on a head of a user Px. The AR glasses 30 can not only display digital information superimposed in a visual field from both eyes or one eye of the user Px, but also enhance, attenuate, or delete an image of a specific real object.

In the example illustrated in FIG. 2, a display unit 331 included in the AR glasses 30 includes a first display unit 331R for a right eye and a second display unit 331L for a left eye. The first display unit 331R is provided to be located in front of the right eye of the user Px when the user Px wears the AR glasses 30. Also, the second display unit 331L for the left eye is provided to be located in front of the left eye of the user Px when the user Px wears the AR glasses 30. The display unit 331 is transparent or translucent. The user Px can visually recognize scenery in the real space through the display unit 331. The first display unit 331R and the second display unit 331L of the display unit 331 are independently display-driven, and can three-dimensionally display an operation object.

Furthermore, in the example illustrated in FIG. 2, a microphone 315 that acquires a voice or the like of the user Px is provided at a frame surrounding the display unit 331 of the AR glasses 30 near the first display unit 331R. The AR glasses 30 can operate according to a voice input of the user Px. In addition, a camera 311 that captures an image around the user Px is provided at the frame surrounding the display unit 331 of the AR glasses 30 near the second display unit 331L. The AR glasses 30 can analyze the image acquired by the camera 311 to identify an object existing around the user Px and estimate a position of the object.

### 3. Example of Configuration of Device

<3-1. Configuration of Hand Sensor>

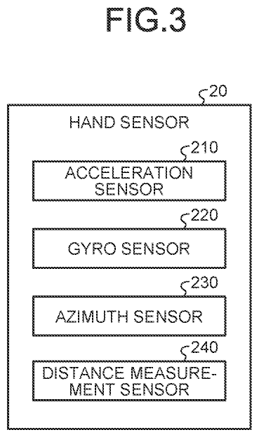

Hereinafter, a functional configuration of the hand sensor 20 constituting the AR glasses system 1A will be described. FIG. 3 is a block diagram illustrating an example of a functional configuration of the hand sensor according to the embodiment of the present disclosure.

As illustrated in FIG. 3, the hand sensor 20 includes an acceleration sensor 210, a gyro sensor 220, an azimuth sensor 230, and a distance measurement sensor 240.

The acceleration sensor 210 detects an acceleration acting on the hand sensor 20. The gyro sensor 220 detects a rotation angular velocity (posture) of the hand sensor 20, for example, on an up-down axis (yaw axis), a left-right axis (pitch axis), and a front-back axis (roll axis). The gyro sensor 220 may include either three axes or nine axes. The azimuth sensor 230 detects an azimuth that which the hand sensor 20 is directed. The azimuth sensor 230 can be realized by, for example, a geomagnetic sensor. The acceleration sensor 210, the gyro sensor 220, and the azimuth sensor 230 may be configured by an inertial measurement unit (IMU).

The distance measurement sensor 240 detects a distance between the hand sensor 20 and an object existing in the real space. The distance measurement sensor 240 can be realized by, for example, a time of flight (ToF) sensor.

The hand sensor 20 transmits, to the AR glasses 30, the result (information) of detecting the posture, position, and movement of the hand of the user Px and information on the distance between the hand sensor 20 and the object detected by the sensors.

<3-2. Configuration of AR Glasses>

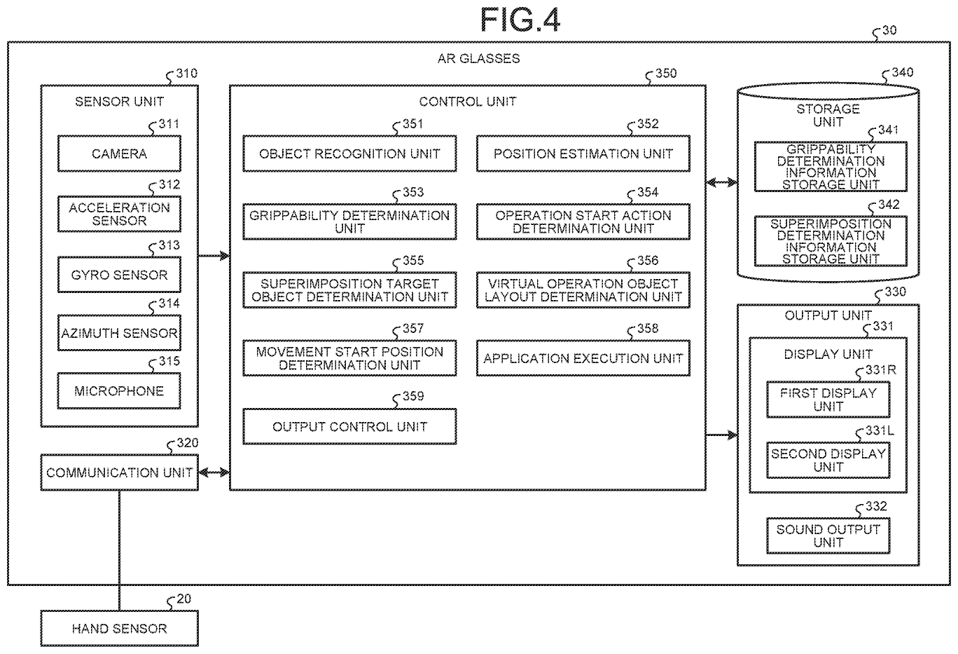

Hereinafter, a functional configuration of the AR glasses 30 according to the embodiment will be described. FIG. 4 is a block diagram illustrating an example of a functional configuration of the AR glasses according to the embodiment of the present disclosure.

As illustrated in FIG. 4, the AR glasses 30 include a sensor unit 310, a communication unit 320, an output unit 330, a storage unit 340, and a control unit 350.

The sensor unit 310 includes a camera 311, an acceleration sensor 312, a gyro sensor 313, an azimuth sensor 314, and a microphone 315.

The camera 311 captures an image in a line-of-sight direction of the user Px wearing the AR glasses 30. The camera 311 is provided at a position where an image can be captured in the line-of-sight direction of the user Px. The camera 311 can acquire an image of an object existing around the AR glasses 30. The hand of the user Px may be included in the image acquired by the camera 311. The camera 311 can be realized by, for example, an RGB camera capable of outputting a captured image in red (R), green (G), and blue (B) colors.

In addition, the camera 311 may include a ToF camera capable of acquiring a distance to a target on the basis of a time difference between a light emission timing and a light reception timing.

The acceleration sensor 312 detects an acceleration acting on the AR glasses 30. The gyro sensor 313 detects a rotation angular velocity (posture) of the AR glasses 30, for example, on an up-down axis (yaw axis), a left-right axis (pitch axis), and a front-back axis (roll axis). The azimuth sensor 314 detects an azimuth in which the AR glasses 30 are directed. That is, the direction detected by the azimuth sensor 314 corresponds to a direction (a line-of-sight direction) that the user Px wearing the AR glasses 30 faces.

The microphone 315 acquires a sound uttered by the user wearing the AR glasses 30 and an environmental sound generated from a sound source around the user. The microphone 315 may be constituted by, for example, a single sound acquisition element or a plurality of sound acquisition elements.

The communication unit 320 communicates with the hand sensor 20 by wireless communication or wired communication. The communication unit 320 communicates with the hand sensor 20 by wireless communication, for example, using Bluetooth (registered trademark). The communication method by which the communication unit 320 communicates with the hand sensor 20 is not limited to Bluetooth (registered trademark). Furthermore, the communication unit 320 can communicate with an external device via a network such as the Internet.

The output unit 330 includes a display unit 331 and a sound output unit 332. The display unit 331 includes a first display unit 331R for a right eye and a second display unit 331L for a left eye. The display unit 331 includes a transmissive display positioned in front of the eyes of the user Px wearing the AR glasses 30. The display unit 331 displays a virtual operation object superimposed on a real space, thereby expanding the real space viewed from the user wearing the AR glasses 30. The display unit 331 performs display control according to a display control signal from the control unit 350.

The sound output unit 332 outputs a sound related to the operation object displayed on the display unit 331. The sound output unit 332 is constituted by a speaker or an earphone provided at a position where the user Px wearing the AR glasses 30 can hear the output sound. The sound output unit 332 converts a sound signal supplied from the control unit 350 into a sound as aerial vibration and outputs the sound. Furthermore, the sound output by the sound output unit 332 is not limited to the sound related to the operation object, and the sound output unit 332 can output sounds according to sound signals corresponding to various contents or applications.

The storage unit 340 stores programs, data, and the like for implementing various processing functions to be executed by the control unit 350. The storage unit 340 is realized by, for example, a semiconductor memory element such as a random access memory (RAM) or a flash memory, or a storage device such as a hard disk or an optical disk. The programs stored in the storage unit 340 includes a program for implementing a processing function corresponding to each unit of the control unit 350. The programs stored in the storage unit 340 include an operating system (OS) and application programs such as an AR application program. The AR application program (hereinafter referred to as an “AR program”) is an application program that provides various functions for displaying a virtual operation object to be superimposed on a reality space visually recognized by the user.

In the example illustrated in FIG. 4, the storage unit 340 includes a grippability determination information storage unit 341 and a superimposition determination information storage unit 342.

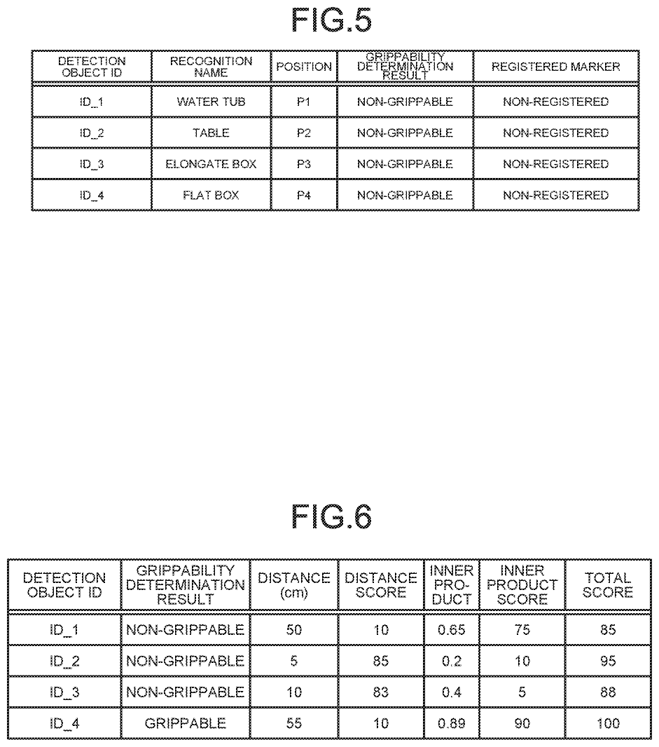

The grippability determination information storage unit 341 stores grippability determination information regarding a result of determining whether or not a recognition object is grippable through a grippability determination unit 353 to be described later. FIG. 5 is a diagram illustrating an outline of grippability determination information according to the embodiment of the present disclosure. The grippability determination information includes items “detection object ID”, “recognition name”, “position”, “grippability determination result”, and “registered marker”. These items are associated with each other.

The item “detection object ID” is for storing identification information uniquely assigned to an object detected from a camera image. This identification information is acquired by processing of recognition from the camera image through an object recognition unit 351 to described later. The item “recognition name” is for storing an object recognition result assigned to the object detected from the camera image. This recognition result is acquired by processing of recognition from the camera image through the object recognition unit 351 to described later. The item “position” is for storing information on a three-dimensional position of the object detected from the camera image. This three-dimensional position information is acquired by position estimation processing through a position estimation unit 352 to be described later. The item “grippability determination result” is for storing a result of determining whether or not the recognition object is grippable through the grippability determination unit 353 to be described later. The item “registered marker” is for storing an AR marker (an example of mark information) assigned to the recognition object determined to be grippable by the grippability determination unit 353.

The grippability determination information illustrated in FIG. 5 indicates that all objects detected from a camera image are not grippable (“non-grippable”).

The superimposition determination information storage unit 342 stores superimposition determination information related to processing of determining a superimposition target object through a superimposition target object determination unit 355 to be described later. FIG. 6 is a diagram illustrating an outline of superimposition determination information according to the embodiment of the present disclosure. The superimposition determination information includes items “detection object ID”, “grippability determination result”, “distance (cm)”, “distance score”, “inner product”, “inner product score”, and “total score”. These items are associated with each other.

The item “detection object ID” is for storing identification information uniquely assigned to an object detected from a camera image, similarly to the item “detection object ID” illustrated in FIG. 5 as described above. The item “grippability determination result” is for storing a result of determining whether or not the recognition object is grippable through the grippability determination unit 353 to be described later, similarly to the item “grippability determination information result” illustrated in FIG. 5 as described above.

The item “distance (cm)” is for acquiring information on a distance to the object detected from the camera image. This identification information is acquired by processing of recognition from the camera image through an object recognition unit 351 to described later. Note that any unit can be adopted as a unit for storing the distance information. The item “distance score” is for storing a score determined according to the distance stored in the item “distance information” described above. For example, a higher score is stored as the distance to the object is smaller.

The item “inner product” is for storing an inner product value calculated on the basis of a positional relationship between the hand of the user Px and the object detected from the camera image. The item “inner product score” is for storing a score determined according to the inner product value stored in the item “inner product” described above. For example, a higher score is stored as the calculated inner product value is larger. The item “total score” is for storing the sum of the “distance score” and the “inner product score” described above.

The superimposition determination information illustrated in FIG. 6 indicates that a flat box, to which “ID_4” is assigned, has the highest total score among all objects detected from the camera image.

The control unit 350 is, for example, a controller. The various functions provided by the control unit 350 are implemented by, for example, a processor or the like executing a program (e.g., an information processing program according to the present disclosure) stored in the AR glasses 30 using a main storage device or the like as a work area. The processor can be realized by a central processing unit (CPU), a micro processing unit (MPU), a system-on-a-chip (SoC), or the like. In addition, the various functions provided by the control unit 350 may be realized by, for example, an integrated circuit such as an application specific integrated circuit (ASIC) or a field programmable gate array (FPGA).

As illustrated in FIG. 4, the control unit 350 includes an object recognition unit 351, a position estimation unit 352, a grippability determination unit 353, an operation start action determination unit 354, a superimposition target object determination unit 355, a virtual operation object layout determination unit 356, a movement start position determination unit 357, an application execution unit 358, and an output control unit 359. The control unit 350 implements or executes actions and functions of the AR glasses 30, which will be described later, by these units.

Each block constituting the control unit 350 may be a software block or a hardware block. For example, each of the above-described blocks may be one software module realized by software (including a microprogram), or may be one circuit block on a semiconductor chip (die). Of course, each of the blocks may be one processor or one integrated circuit. A method of configuring the functional blocks is arbitrary. Note that the control unit 350 may be configured by a functional unit different from the functional unit indicated by each block in FIG. 4.

<3-2-1. Grippability Determination>

Hereinafter, an operation of the AR glasses 30 for determining grippability will be described. The determination of the grippability executed in the AR glasses 30 is implemented by the object recognition unit 351, the position estimation unit 352, and the grippability determination unit 353.

The object recognition unit 351 executes object recognition processing on a camera image acquired from the camera 311. The object recognition unit 351 can execute the object recognition processing using any method. The object recognition unit 351 assigns, to a recognition object detected from the camera image, identification information unique to the recognition object. The object recognition unit 351 assigns an object recognition result to the recognition object detected from the camera image. The object recognition unit 351 registers the identification information in the item “detection object ID” of the grippability determination information storage unit 341, and registers the recognition result in the item “recognition name” of the grippability determination information storage unit 341.

The position estimation unit 352 estimates a three-dimensional position of the object detected from the camera image. The position estimation unit 352 estimates the position of the recognition object on the basis of am RGB image and a distance image acquired from the camera 311. The position estimation unit 352 records the position information in association with the corresponding detection object ID.

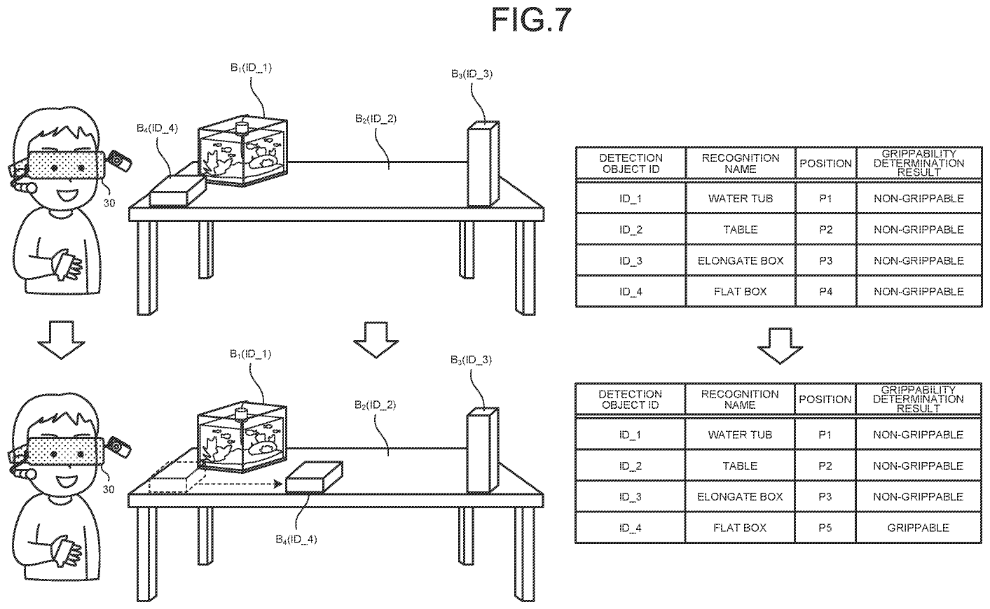

The grippability determination unit 353 determines whether or not the recognition object is grippable by executing position tracking on the recognition object. For example, whenever the AR glasses 30 are activated, the grippability determination unit 353 recognizes an object from a camera image and estimates a position of the object. Then, the grippability determination unit 353 determines whether or not the recognition object is grippable on the basis of whether or not the recognition object has moved greatly between before and after the activation of the AR glasses 30. FIG. 7 is a diagram illustrating an outline of determining whether a recognition object is grippable according to the embodiment of the present disclosure.

As illustrated in FIG. 7, the grippability determination unit 353 determines whether or not each of recognition objects B₁ to B₄ has moved between before and after the activation of the AR glasses 30 by a distance exceeding a predetermined threshold value. As a result of the determination, when the movement distance of the recognition object B₄ among the recognition objects B₁ to B₄ exceeds the predetermined threshold value, the grippability determination unit 353 determines that the recognition object B₄ is grippable. For example, on the premise that an absolute coordinate system of an imaged place is known, the grippability determination unit 353 calculates a movement distance of a recognition object from a change in three-dimensional position of the recognition object between before and after the activation of the AR glasses 30. The grippability determination unit 353 records a determination result (“grippable”) indicating that the recognition object B₄ is grippable in the grippability determination information storage unit 341 in association with the corresponding detection object ID “ID_4”.

In addition, the above-described method of determining whether or not a recognition object is grippable by the grippability determination unit 353 is merely an example, and is not particularly limited to this example. For example, the AR glasses 30 may determine a movement of a recognition object on the basis of a change in relative positional relationship of the recognition object between before and after the activation thereof. Alternatively, in a case where a signal transmitter is mounted on a recognition object in advance, the AR glasses 30 may acquire a signal transmitted from the signal transmitter and determine a movement of the recognition object on the basis of the acquired signal.

Furthermore, the AR glasses 30 are not particularly limited to the example in which a recognition object is determined to be grippable on condition that its movement distance exceeds the threshold value, and the movement may not be set as a condition for grippability. For example, it may be determined whether the user Px of the AR glasses 30 can grip a recognition object on the basis of a size of the hand of the user Px, a size of the recognition object, and the like. Furthermore, in a case where a weight of the recognition object can be estimated, the estimated weight may be taken into consideration when it is determined whether the recognition object is grippable.

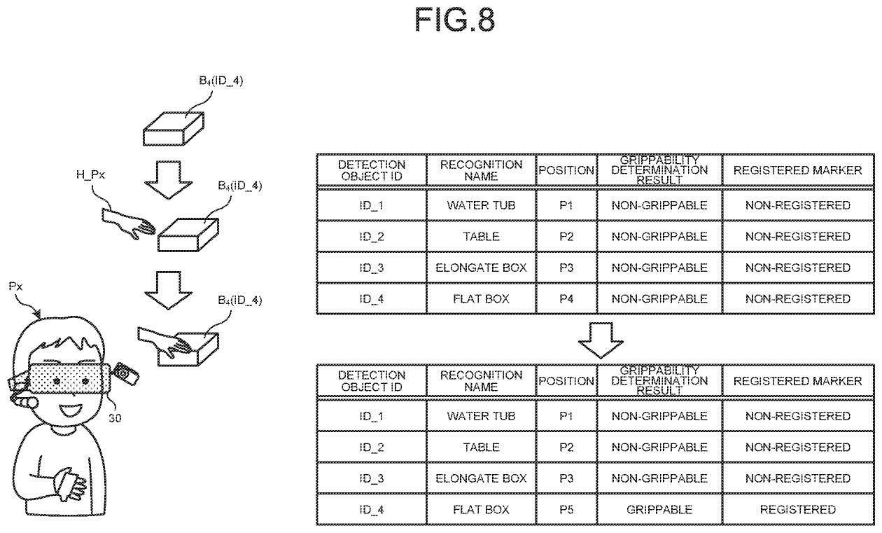

In addition, the grippability determination unit 353 may assign, to a recognition object determined to be grippable, an AR marker indicating that the recognition object is grippable. FIG. 8 is a diagram illustrating an example of registration of mark information according to the embodiment of the present disclosure. As illustrated in FIG. 8, when it is determined that the recognition object B₄, of which the detection object ID is “ID_4”, is grippable, the grippability determination unit 353 generates an AR marker to be assigned to the recognition object B₄. Then, the grippability determination unit 353 updates the item “registered marker” associated with the detection object ID “ID_4” corresponding to the recognition object B₄ in the grippability information from “non-registered” to “registered”. The AR glasses 30 may generate an AR marker and register the AR marker with respect to the recognition object B₄, when the user Px tries to grip the recognition object B₄ determined to be grippable, or when the user Px actually grips the recognition object B₄. As a result, the AR glasses 30 can recognize a grippable object with improved accuracy.

<3-2-2. Determination of Operation Start Action>

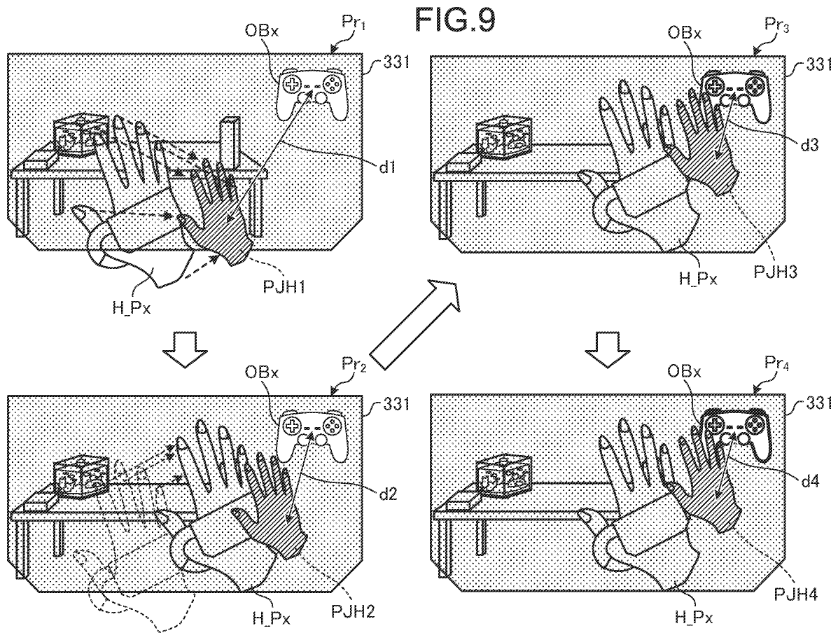

Hereinafter, an operation of the AR glasses 30 for determining an operation start action will be described. The determination of the operation start action executed in the AR glasses 30 is implemented by the operation start action determination unit 354. FIG. 9 is a diagram illustrating an outline of determining an operation start action according to the embodiment of the present disclosure.

The operation start action determination unit 354 acquires a three-dimensional position of a hand of a user (e.g., the user Px) wearing the AR glasses 30 on the basis of distance information acquired by the camera 311. The operation start action determination unit 354 determines whether a movement of the hand of the user of the AR glasses 30 is an operation start action using a virtual operation object OBₓ on the basis of the three-dimensional position of the hand of the user of the AR glasses 30 and a three-dimensional position of the AR glasses 30. That is, the operation start action determination unit 354 determines whether the user of the AR glasses 30 intends to perform an operation using the virtual operation object OBₓ.

As illustrated in FIG. 9, the operation start action determination unit 354 projects the position of the hand H_Px of the user onto a plane defining a display area of the display unit 331, which is a display area of the AR glasses, from a certain point that is not on the plane defining the display area of the display unit 331, which is the display area of the AR glasses. As a result, the operation start action determination unit 354 acquires the projection position PJH of the hand H_Px of the user. The operation start action determination unit 354 continues to calculate a distance d between the projection position PJH of the hand H_Px of the user and the virtual operation object OBₓ until the distance between the projection position PJH and the virtual operation object OBₓ becomes equal to or smaller than a predetermined threshold value D (Steps Pr₁ and Pr₂).

Then, when the distance d3 between the projection position PJH3 and the virtual operation object OBₓ becomes equal to or smaller than the predetermined threshold value D, the operation start action determination unit 354 measures a time for which the hand H_Px of the user has stayed at that position (Step Pr₃). At this time, for example, at the time of measuring the stay time of the hand H_Px of the user, the operation start action determination unit 354 changes a display mode of the virtual operation object OBₓ to indicate that the hand H_Px of the user is located at a position where the virtual operation object OBₓ can be operated.

When the stay time of the hand H_Px of the user exceeds a predetermined period of time (threshold value T), the operation start action determination unit 354 determines that the movement of the hand H_Px of the user of the AR glasses 30 is an operation start action using the virtual operation object OBₓ. At this time, the operation start action determination unit 354 further changes the display mode of the virtual operation object OBₓ in order to notify the user that the operation start action using the virtual operation object OBₓ has been recognized.

<3-2-3. Determination of Superimposition Target Object>

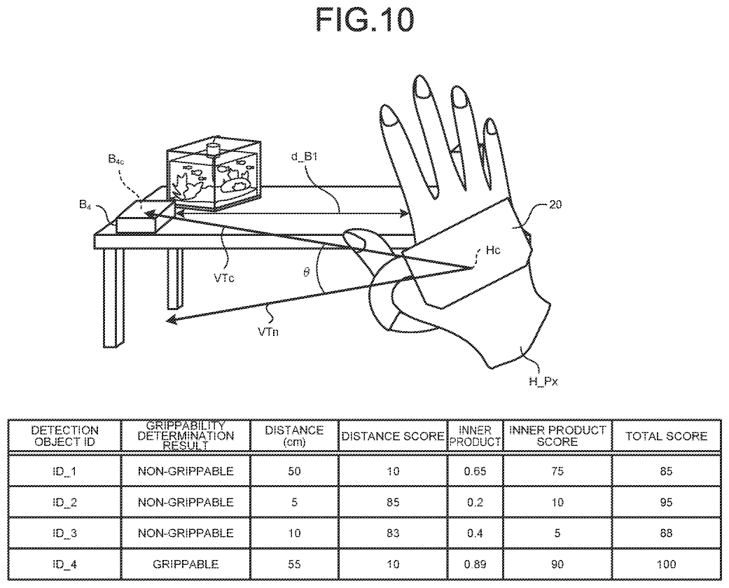

Hereinafter, an operation of the AR glasses 30 for determining a superimposition target object will be described. The determination of the superimposition target object executed in the AR glasses 30 is implemented by the superimposition target object determination unit 355. When an operation start action is recognized by the operation start action determination unit 354, the superimposition target object determination unit 355 determines a superimposition target object on which the virtual operation object is to be superimposed from among a plurality of recognition objects determined to be grippable. FIG. 10 is a diagram illustrating an outline of determining a superimposition target object according to the embodiment of the present disclosure. Note that, although it will be described below that the superimposition target object determination unit 355 performs its processing with respect to each recognition object, the superimposition target object determination unit 355 may perform its processing with respect to only objects determined to be grippable.

As illustrated in FIG. 10, the superimposition target object determination unit 355 acquires a position of a recognition object and a position of the hand H_Px of the user. The superimposition target object determination unit 355 calculates a distance d_B₄ between the recognition object and the hand H_Px of the user on the basis of a position of the recognition object and a position of the hand H_Px of the user. Furthermore, the superimposition target object determination unit 355 may acquire a distance between the hand H_Px of the user and the object from a detection result acquired from the hand sensor 20.

The superimposition target object determination unit 355 determines a distance score that is a score corresponding to the calculated distance d_B₄. The distance score is determined based on predetermined criteria. For example, the distance score increases as the distance d_B₄ decreases in advance. That is, the superimposition target object determination unit 355 highly evaluates a recognition object closer to the hand H_Px of the user as a superimposition target.

In addition, the superimposition target object determination unit 355 calculates an inner product between a vector VT_{c} connecting the center B_{4c} of the recognition object and the center H_{c} of the hand H_Px of the user to each other and a normal vector VTₙ defining a plane including the hand H_Px of the user. The superimposition target object determination unit 355 determines an inner product score that is a score corresponding to the calculated inner product value. The inner product score is determined based on predetermined criteria. For example, the inner product score increases as an angle θ between the vector VT_{c} and the normal vector VTₙ decreases. That is, the superimposition target object determination unit 355 highly evaluates a recognition object facing a palm of the hand H_Px of the user as a superimposition target.

The superimposition target object determination unit 355 calculates a total score obtained by summing up the distance score and the inner product score. Then, the superimposition target object determination unit 355 determines a recognition object having the highest total score as a superimposition target object. The example illustrated in FIG. 10 indicates that the recognition object of which the detection object ID is “ID_4” has the highest total score.

<3-2-4. Determination of Layout of Virtual Operation Object>

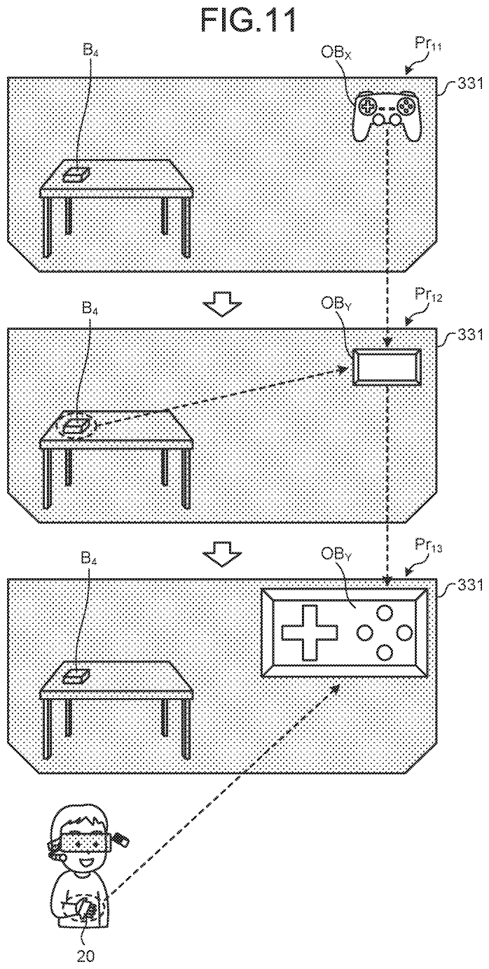

Hereinafter, an operation of the AR glasses 30 for determining a layout of a virtual operation object will be described. The determination of the layout of the operation executed in the AR glasses 30 is implemented by the virtual operation object layout determination unit 356. The virtual operation object layout determination unit 356 acquires geometric information for the superimposition target object, and determines a layout of the virtual operation object on the basis of the acquired geometric information. FIG. 11 is a diagram illustrating an outline of determining an operation start action according to the embodiment of the present disclosure.

As illustrated in FIG. 11, the virtual operation object layout determination unit 356 displays the virtual operation object OBₓ in the display area of the display unit 331 in a preset initial shape (Step Prig).

The virtual operation object layout determination unit 356 changes a layout (shape) of the virtual operation object OBₓ on the basis of the geometric information for the superimposition target object (Step Pr₁₂). Specifically, the virtual operation object layout determination unit 356 acquires geometric information for the recognition object B₄ determined as a superimposition target object. For example, the virtual operation object layout determination unit 356 acquires geometric information indicating that the recognition object B₄ is a plate-like object having a flat surface from a recognition result of the object recognition unit 351. The virtual operation object layout determination unit 356 displays, on the display unit 331, a virtual operation object OB_{Y} obtained by changing the shape of the virtual operation object OBₓ to a plate shape on the basis of the acquired geometric information. That is, the virtual operation object layout determination unit 356 changes the shape of the virtual operation object OBₓ to be suitable for superimposition on the recognition object B₄.

The virtual operation object layout determination unit 356 acquires disassembility information for the hand sensor 20 worn on the hand of the user Px, and determines a layout (configuration) of the virtual operation object OB_{Y} based on the acquired disassembility information (Step Pr₁₃). Specifically, when it is determined that a key operation can be detected by the disassembility of the hand sensor 20, the virtual operation object layout determination unit 356 changes a surface of the virtual operation object OB_{Y} to have a configuration in which a cross key and a round button are arranged.

<3-2-5. Movement of Virtual Operation Object>

Hereinafter, an operation of the AR glasses 30 for moving a virtual operation object will be described. The movement of the virtual operation object executed in the AR glasses 30 is implemented by the movement start position determination unit 357, the application execution unit 358, and the output control unit 359.

The movement start position determination unit 357 determines a movement start position of the operation object. The movement start position determination unit 357 determines the movement start position of the virtual operation object on the basis of a projection position of a hand of a user (e.g., the user Px) and a position of a recognition object as a superimposition target object.

The application execution unit 358 executes an application program under an execution environment provided by the OS. The application execution unit 358 may simultaneously execute a plurality of application programs in parallel. By executing the AR program, the application execution unit 358 implements various functions for presenting, to the user, the virtual operation object displayed in a superimposed state on the reality space visually recognized by the user of the AR glasses 30.

For example, the application execution unit 358 can acquire three-dimensional information for the surroundings on the basis of a camera image acquired by the camera 311. In a case where the camera 311 includes a ToF camera, the application execution unit 358 can acquire the three-dimensional information for the surroundings on the basis of distance information obtained using the function of the ToF camera. The application execution unit 358 can analyze a sound signal acquired by the microphone 315 to acquire an instruction according to a sound input of a user of the AR glasses 30.

Furthermore, the application execution unit 358 executes processing of detecting a movement of a hand of the user in a state where the virtual operation object is displayed, and presenting the virtual operation object to the user while moving the virtual operation object to approach the superimposition target object in conjunction with the detected movement of the hand of the user.

Furthermore, when moving the virtual operation object, the application execution unit 358 executes processing of moving the virtual operation object on the basis of a projection position of the hand of the user, at which the hand of the user is projected onto a plane defining a display area of the display unit 331 from a certain point that is not on the plane defining the display area of the display unit 331, and a display position of the virtual operation object in the display area.

Furthermore, when moving the virtual operation object, the application execution unit 358 executes processing of moving the virtual operation object in such a manner that the projection position of the hand of the user and the display position of the virtual operation object do not overlap each other.

Furthermore, when moving the virtual operation object, the application execution unit 358 executes processing of moving the virtual operation object along a line connecting the projection position of the hand of the user to a projection position of the superimposition target object, at which a position of the superimposition target object is projected onto the plane defining the display area of the display unit 331, in such a manner that the display position of the virtual operation object precedes the projection position of the hand of the user.

Furthermore, the application execution unit 358 executes processing of moving the virtual operation object until the virtual operation object reaches the projection position of the superimposition target object.

Furthermore, after moving the virtual operation object until the virtual operation object reaches the projection position of the superimposition target object, the application execution unit 358 executes processing of presenting, to the user, the operation object displayed in a superimposed state on the superimposition target object.

The output control unit 359 controls output to the display unit 331 and the sound output unit 332 on the basis of a result of executing the AR program by the application execution unit 358. For example, the output control unit 359 specifies a movement (visual field range) of a head of a user on the basis of detection results of the acceleration sensor 312, the gyro sensor 313, the azimuth sensor 314, and the like included in the sensor unit 310. Then, the output control unit 359 controls the display of the virtual operation object on the display unit 331 to follow the movement (the movement in the visual field range) of the head of the user.

In addition, the output control unit 359 displays the virtual operation object in a superimposed state on the reality space visually recognized by the user through the first display unit 331R and the second display unit 331L.

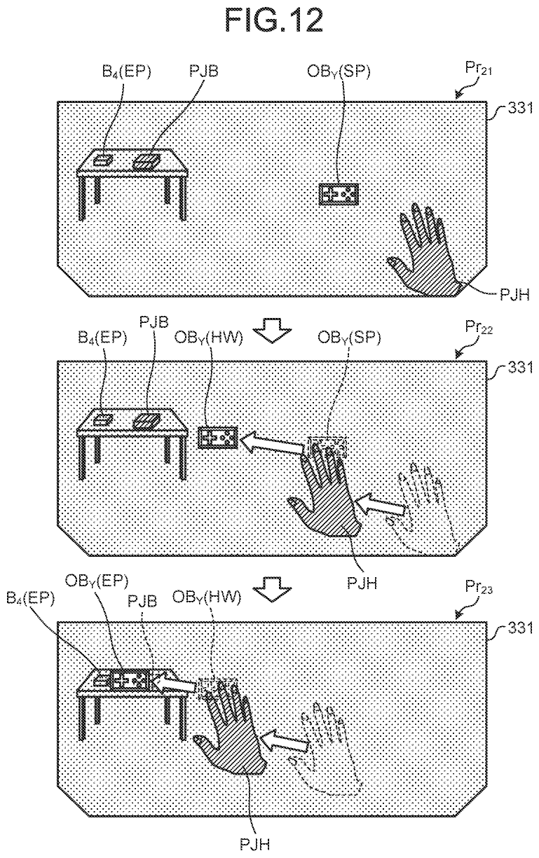

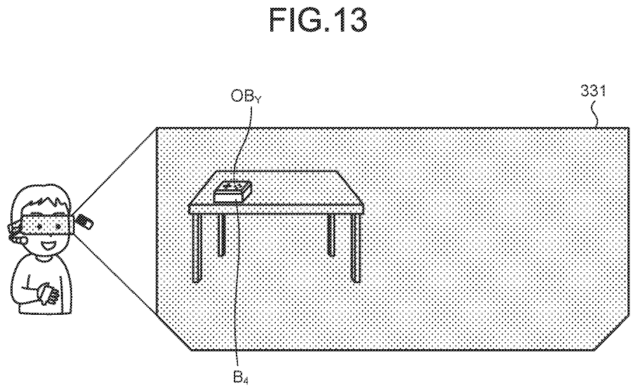

FIG. 12 is a diagram illustrating an outline of moving a virtual operation object according to the embodiment of the present disclosure. FIG. 13 is a diagram illustrating an example in which the virtual operation object is displayed in a superimposed state according to the embodiment of the present disclosure. As illustrated in FIG. 12, the movement start position determination unit 357 determines a movement start position SP of the virtual operation object OB_{Y} on a line connecting the projection position PJH (e.g., a projection position of a middle finger) of the hand of the user (e.g., the user Px) of the AR glasses 30 to a projection position PJB of the superimposition target object (the recognition object B₄), at which a position of the superimposition target object (the recognition object B₄) is projected onto the plane defining the display area of the display unit 331. For example, the movement start position determination unit 357 can determine, as a movement start position SP, an intermediate point of a line segment connecting the projection position PJH (e.g., the projection position of the middle finger) of the hand of the user and the projection position PJB of the superimposition target object (the recognition object B₄) to each other.

The application execution unit 358 instructs the output control unit 359 to display the virtual operation object OB_{Y} at the movement start position SP. The output control unit 359 displays the virtual operation object OB_{Y} at a position corresponding to the movement start position SP on the display unit 331 according to the instruction of the application execution unit 358 (Step Pr₂₁).

After the virtual operation object OB_{Y} is displayed at the movement start position SP, the application execution unit 358 detects a movement of the hand of the user in a state where the virtual operation object OB_{Y} is displayed, and determines a planned movement route for moving the virtual operation object OB_{Y} in such a manner as to approach the superimposition target object (the recognition object B₄) in conjunction with the detected movement of the hand of the user. For example, when moving the virtual operation object OB_{Y}, the application execution unit 358 determines a planned movement route for moving the virtual operation object OB_{Y} in such a manner that the projection position PJH of the hand of the user does not overlap the display position of the virtual operation object OB_{Y}. Specifically, the application execution unit 358 determines a planned movement route for moving the virtual operation object OB_{Y} along a line connecting the projection position PJH of the hand of the user and the projection position PJB of the superimposition target object (the recognition object B₄) to each other in such a manner that the display position of the virtual operation object OB_{Y} precedes the projection position PJH of the hand of the user. The output control unit 359 controls the display of the virtual operation object OB_{Y} on the display unit 331 in accordance with the planned movement route determined by the application execution unit 358 (Step Pr₂₂). The example illustrated in FIG. 12 indicates a state in which the virtual operation object OB_{Y} moves to an intermediate point HW of the planned movement route ahead of the projection position PJH of the hand of the user.

Then, when the virtual operation object OB_{Y} is moved until the virtual operation object OB_{Y} reaches the projection position PJB of the superimposition target object (the recognition object B₄), the application execution unit 358 determines to display the virtual operation object OB_{Y} in a superimposed state on the superimposition target object (the recognition object B₄).

As illustrated in FIG. 13, according to the determination of the application execution unit 358, the output control unit 359 controls the display of the display unit 331 in such a manner that the virtual operation object OB_{Y} is displayed in a superimposed state on the superimposition target object (the recognition object B₄), and presents the virtual operation object OB_{Y} to the user.

### 4. Example of Processing Procedure

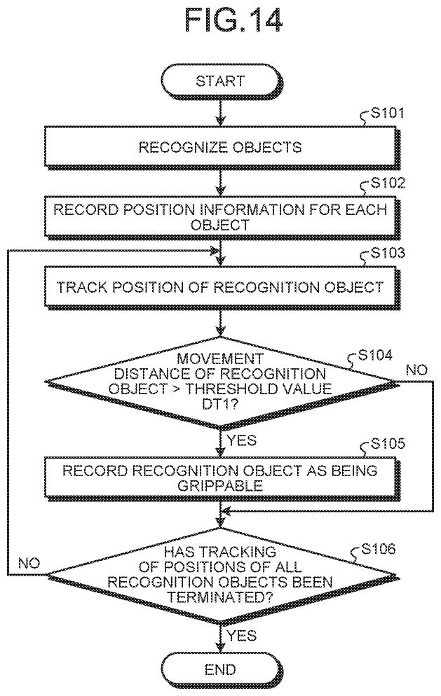

Hereinafter, examples of processing procedures of the AR glasses 30 according to the embodiment will be described with reference to FIGS. 14 to 18.

<4-1. Processing of Determination of Grippability>

FIG. 14 is a flowchart illustrating an example of a processing procedure for determining grippability according to the embodiment of the present disclosure. The processing procedure illustrated in FIG. 14 is executed by the control unit 350 of the AR glasses 30. For example, the processing procedure illustrated in FIG. 14 is executed by activating the AR glasses 30.

As illustrated in FIG. 14, the object recognition unit 351 recognizes objects from a camera image (Step S101). The position estimation unit 352 estimates a position of each of the recognition objects and records the position information (Step S102).

The grippability determination unit 353 tracks the position of the recognition object (Step 103). Then, the grippability determination unit 353 determines whether or not a movement distance of the recognition object exceeds a predetermined threshold value DT1 (Step S104).

As a result of the determination, when it is determined that the movement distance of the recognition object exceeds the threshold value DT1 (Step S104; Yes), the grippability determination unit 353 records the recognition object as being grippable (Step S105).

The grippability determination unit 353 determines whether or not the tracking of the positions of all the recognition objects has been terminated (Step S106). When it is determined that the tracking of the positions of all the recognition objects has been terminated (Step S106; Yes), the grippability determination unit 353 ends the processing procedure illustrated in FIG. 14. On the other hand, when it is determined that the tracking of the positions of all the recognition objects has not been terminated (Step S106; No), the grippability determination unit 353 returns to the processing of Step S103 described above to execute processing on a recognition object for which tracking is not completed.

<4-2. Processing of Determination of Operation Start Action>

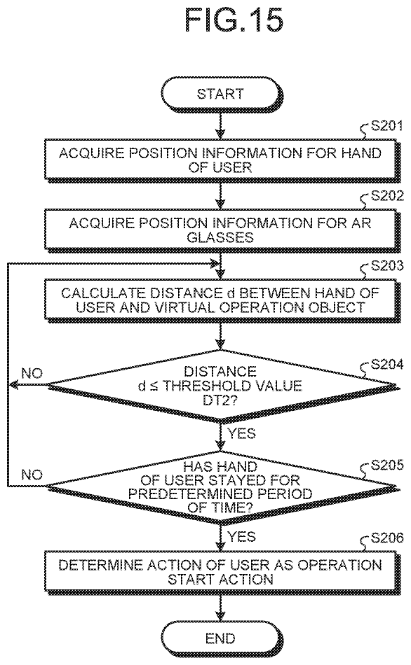

FIG. 15 is a flowchart illustrating an example of a processing procedure for determining an operation start action according to the embodiment of the present disclosure. The processing procedure illustrated in FIG. 15 is executed by the control unit 350 of the AR glasses 30.

As illustrated in FIG. 15, the operation start action determination unit 354 acquires position information (a three-dimensional position) for the hand of the user (e.g., the user Px) wearing the AR glasses 30 (Step S201). In addition, the operation start action determination unit 354 acquires position information (a three-dimensional position) for the AR glasses 30 (Step S202).

Subsequently, the operation start action determination unit 354 calculates a distance d between the hand of the user and a virtual operation presented to the user on the basis of the position information for the hand of the user and the position information for the AR glasses (Step S203). Specifically, on the basis of the three-dimensional position of the hand of the user and the three-dimensional position of the AR glasses 30, the operation start action determination unit 354 projects the position of the hand of the user onto a plane defining a display area of the display unit 331, which is a display area of the AR glasses, from a certain point that is not on the plane defining the display area of the display unit 331, which is the display area of the AR glasses 30. As a result, the operation start action determination unit 354 acquires a projection position of the hand of the user. Accordingly, the operation start action determination unit 354 calculates a distance d between the projection position of the hand of the user and the virtual operation object presented in the display area of the display unit 331.

The operation start action determination unit 354 determines whether or not the distance d between the hand of the user and the virtual operation object presented to the user is equal to or smaller than a predetermined threshold value DT2 (Step S204).

When it is determined that the distance d between the hand of the user and the virtual operation object presented to the user is equal to or smaller than the threshold value DT2 (Step S204; Yes), the operation start action determination unit 354 determines whether or not the hand of the user has stayed for a predetermined period of time (Step S205).

When it is determined that the hand of the user has stayed for the predetermined period of time (Step S205; Yes), the operation start action determination unit 354 determines the action of the user as an operation start action (Step S206), and ends the processing procedure illustrated in FIG. 15.

In Step S204 described above, when it is determined that the distance d between the hand of the user and the virtual operation object presented to the user is not equal to or smaller than the threshold value DT2 (Step S204; No), the operation start action determination unit 354 returns to the processing of Step S203 described above to continue to calculate a distance d.

In Step S205 described above, when it is determined that the hand of the user has not stayed for the predetermined period of time (Step S205; No), the operation start action determination unit 354 returns to the processing of Step S203 described above to continue to calculate a distance d.

<4-3. Processing of Determination of Superimposition Target Object>

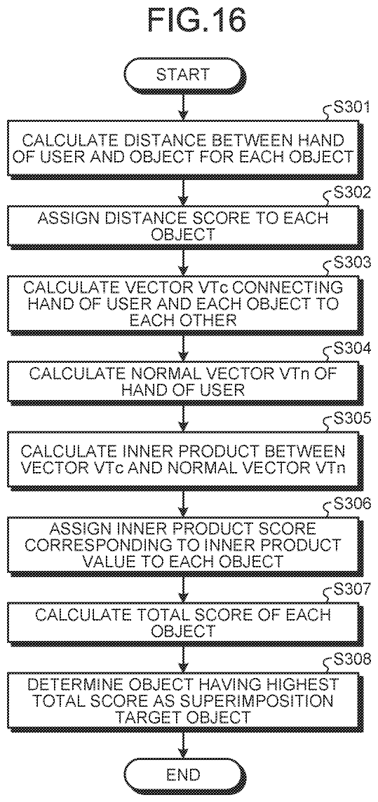

FIG. 16 is a flowchart illustrating an example of a processing procedure for determining a superimposition target object according to the embodiment of the present disclosure. The processing procedure illustrated in FIG. 16 is executed by the control unit 350 of the AR glasses 30.

As illustrated in FIG. 16, the superimposition target object determination unit 355 calculates a distance between the hand of the user and each object for each object (Step S301). Note that, in Step S301, each object is an object determined to be grippable among the recognition objects detected from the camera image.

The superimposition target object determination unit 355 assigns a distance score to each object according to the distance to the hand of the user (Step S302).

Subsequently, the superimposition target object determination unit 355 calculates a vector VT_{c} connecting (the center of the palm of) the hand of the user and (the center of) each object to each other (Step S303).

Subsequently, the superimposition target object determination unit 355 calculates a normal vector VTₙ defining a plane including the hand of the user (Step S304).

Subsequently, the superimposition target object determination unit 355 calculates an inner product between the vector VT_{c} corresponding to each object and the normal vector VTₙ (Step S305).

Subsequently, the superimposition target object determination unit 355 assigns an inner product score corresponding to the inner product value of each object (Step S306).

Subsequently, the superimposition target object determination unit 355 calculate a total score of each object by summing up the distance score and the inner product score for each object (Step S307).

The superimposition target object determination unit 355 determines an object having the highest total score as a superimposition target object (Step S308), and ends the processing procedure illustrated in FIG. 16.

<4-4. Processing of Determination of Layout of Virtual Operation Object>

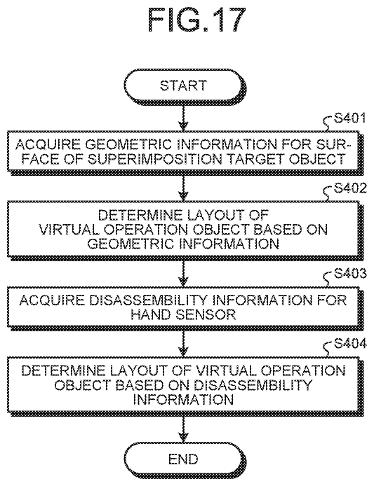

FIG. 17 is a flowchart illustrating an example of a processing procedure for determining a layout of the virtual operation object according to the embodiment of the present disclosure. The processing procedure illustrated in FIG. 17 is executed by the control unit 350 of the AR glasses 30.

As illustrated in FIG. 17, the virtual operation object layout determination unit 356 acquires geometric information for the superimposition target object (Step S401).

The virtual operation object layout determination unit 356 determines a layout (shape) of the virtual operation object on the basis of the acquired geometric information (Step S402).

Subsequently, the virtual operation object layout determination unit 356 acquires disassembility information for the hand sensor 20 (Step S403).

The virtual operation object layout determination unit 356 determines a layout (surface configuration) of the virtual operation object on the basis of the acquired disassembility information for the hand sensor 20 (Step S404), and ends the processing procedure illustrated in FIG. 17.

<4-5. Processing of Movement of Virtual Operation Object>

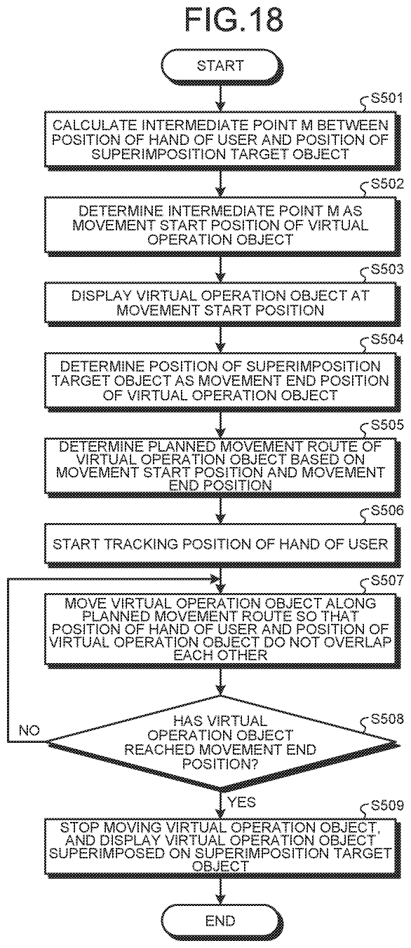

FIG. 18 is a flowchart illustrating an example of a processing procedure for determining a layout of the virtual operation object according to the embodiment of the present disclosure. The processing procedure illustrated in FIG. 18 is executed by the control unit 350 of the AR glasses 30.

As illustrated in FIG. 18, the movement start position determination unit 357 calculates an intermediate point M between the position of the hand of the user and the position of the superimposition target object (Step S501). In Step S501, the position of the hand of the user and the position of the superimposition target object are projection positions at which the position of the hand of the user and the position of the superimposition target object are projected onto the display area of the display unit 331, respectively. Then, the movement start position determination unit 357 determines the intermediate point M as a movement start position of the virtual operation object (Step S502).

The output control unit 359 displays the virtual operation object at the movement start position in accordance with an instruction of the application execution unit 358 (Step S503).

The application execution unit 358 determines the position (projection position) of the superimposition target object as a movement end position of the virtual operation object (Step S504).

The application execution unit 358 determines a planned movement route of the virtual operation object on the basis of the movement start position and the movement end position (Step S505).

The application execution unit 358 starts tracking (position tracking) the position of the hand of the user (Step S506).

In cooperation with the output control unit 359, the application execution unit 358 moves the virtual operation object along the planned movement route in such a manner that the position of the hand of the user and the position of the virtual operation object do not overlap each other (Step S507).

The application execution unit 358 determines whether the virtual operation object has reached the movement end position (Step S508).

When it is determined that the virtual operation object has not reached the movement end position (Step S508; No), the application execution unit 358 returns to Step S507 described above to continue to move the virtual operation object in cooperation with the output control unit 359.

On the other hand, when it is determined that the virtual operation object has reached the movement end position (Step S508; Yes), the application execution unit 358 stops moving the virtual operation object and displays the virtual operation object in a superimposed state on the superimposition target object in cooperation with the output control unit 359 (Step S509), and ends the processing procedure illustrated in FIG. 18.

### 5. Modifications

<5-1. Concerning Superimposition Target Object>

When determining a superimposition target object, the superimposition target object determination unit 355 of the control unit 350 may exclude an object that is not suitable for the user to grip from superimposition target object candidates, among the recognition objects, on the basis of the object recognition result. Examples of objects that are not suitable to grip include an object containing something that may be spilled out when operated in a gripped state, and a heated object that may cause scald.

In addition, when determining a superimposition target object, the superimposition target object determination unit 355 may give priority to own belongings registered in advance, among the recognition objects, on the basis of the object recognition result.

In addition, when determining a superimposition target object, the superimposition target object determination unit 355 may give priority to an object placed at a short distance among the recognition objects.

In addition, the superimposition target object determination unit 355 may determine a superimposition target object on the basis of a characteristic of the user. Examples of characteristics of the user include a body measurement value, handicap information, and dominant arm information.

For example, in a case where a height of a user has been acquired in advance, the superimposition target object determination unit 355 may determine a superimposition target object on the basis of the height of the user. For example, when the user's height is 180 cm, an object placed at a level of about 170 cm can be determined as a superimposition target object among the recognition objects.

In addition, for example, in a case where information indicating that a user has color blindness for blue has been acquired in advance, the superimposition target object determination unit 355 may determine a superimposition target object from objects other than an object having a blue surface among recognition objects.

In addition, for example, in a case where information indicating that a user's left arm is a dominant arm has been acquired in advance, the superimposition target object determination unit 355 may determine an object placed on the left side in front of the user, among the recognition objects, as a superimposition target object.

In addition, the superimposition target object determination unit 355 may determine a superimposition target object on the basis of action information for the user. For example, in a case where it is detected as user's action that a user moves on foot, the superimposition target object determination unit 355 may determine a superimposition target object from objects in front of the user among the recognition objects.

In addition, the superimposition target object determination unit 355 may determine a plurality of superimposition target objects. For example, in a case where two superimposition target objects are determined by the superimposition target object determination unit 355, the AR glasses 30 may divide the virtual operation object into two virtual operation objects and individually superimpose the virtual operation objects on the superimposition target objects in a one-to-one manner.

In addition, the superimposition target object determination unit 355 may determine what is worn by a user, such as the hand sensor 20, as a superimposition target object, rather than determining a superimposition target object from among real objects around the user.

In addition, the AR glasses 30 may newly determine a superimposition target object according to a movement status of a user.

In addition, the AR glasses 30 may directly display a virtual operation object electronically on a display included in an electronic device such as a smartphone or a wearable terminal, without superimposing the virtual operation object on a superimposition target object that is a real object.

<5-2. Concerning Layout of Virtual Operation Object>

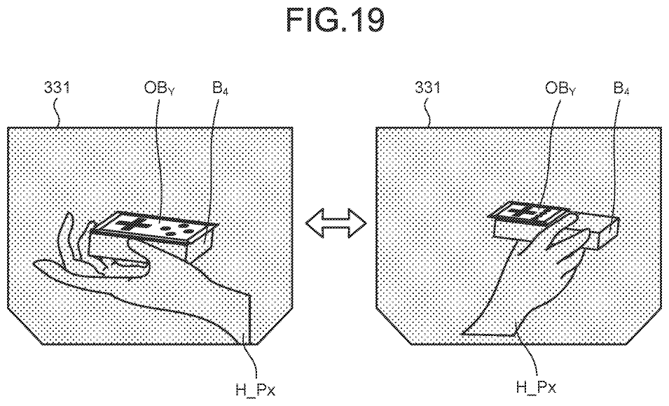

In the above-described embodiment, the virtual operation object layout determination unit 356 may change the layout of the virtual operation object on the basis of a position of the hand of the user at the time of gripping the superimposition target object. FIG. 19 is a diagram illustrating an example in which the layout of the virtual operation object is changed according to a modification.

As illustrated in the left diagram of FIG. 19, in a case where a position of the hand H_Px of the user at the time of gripping the superimposition target object does not interfere with a display position of the virtual operation object OB_{Y} on the display unit 331, the virtual operation object layout determination unit 356 does not change the layout of the virtual operation object OB_{Y}. On the other hand, as illustrated in the right diagram of FIG. 19, in a case where a position of the hand of the user at the time of gripping the superimposition target object interferes with a display position of the virtual operation object OB_{Y} on the display unit 331, the virtual operation object layout determination unit 356 changes the layout of the virtual operation object OB_{Y}.

<5-3. Provision of Tactile Stimulus in Case where Virtual Operation Object is Moved>

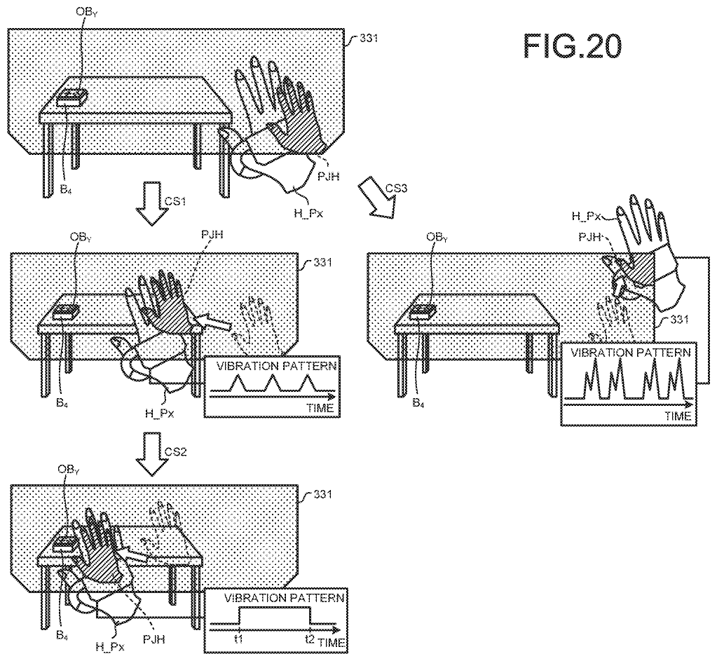

In the above-described embodiment, in a case where the virtual operation object is presented to the user in advance with the movement start position being the movement end position, the application execution unit 358 may instruct the hand sensor 20 to output vibration in a predetermined waveform pattern according to a change in positional relationship between the position of the hand of the user and the virtual operation object. FIG. 20 is a diagram illustrating an example in which a tactile stimulus is provided in a case where the virtual operation object is moved according to a modification.

As illustrated in FIG. 20, first, the application execution unit 358 presents, to the user, the virtual operation object OB_{Y} displayed in a superimposed state on the superimposition target object (the recognition object B₄), with the movement start position being the movement end position.

When the projection position PJH of the hand H_Px of the user is close to the movement end position (the virtual operation object OB_{Y}) (CS1), the application execution unit 358 transmits an instruction to the hand sensor 20 to output vibration in a preset periodic vibration pattern. The hand sensor 20 vibrates according to the instruction from the AR glasses.

At a stage (time t1) when the projection position PJH of the hand H_Px of the user approaches the movement end position (the virtual operation object OB_{Y}) and the virtual operation object OB_{Y} can be operated, the application execution unit 358 transmits an instruction to the hand sensor 20 to vibrate in a steady vibration pattern from the periodic vibration pattern. The hand sensor 20 vibrates according to the instruction from the AR glasses 30. In addition, at a stage (time t2) when the operation of the virtual operation object OB_{Y} is disclosed, the application execution unit 358 transmits an instruction to the hand sensor 20 to vibrate. The hand sensor 20 stops vibrating according to the instruction from the AR glasses.

When the projection position PJH of the hand H_Px of the user is far away from the movement end position (the virtual operation object OB_{Y}) (CS2), the application execution unit 358 transmits an instruction to the hand sensor 20 to output vibration in a vibration pattern having a larger amplitude than that in the case of CS1. The hand sensor 20 vibrates according to the instruction from the AR glasses 30.

<5-4. Change of System Configuration>

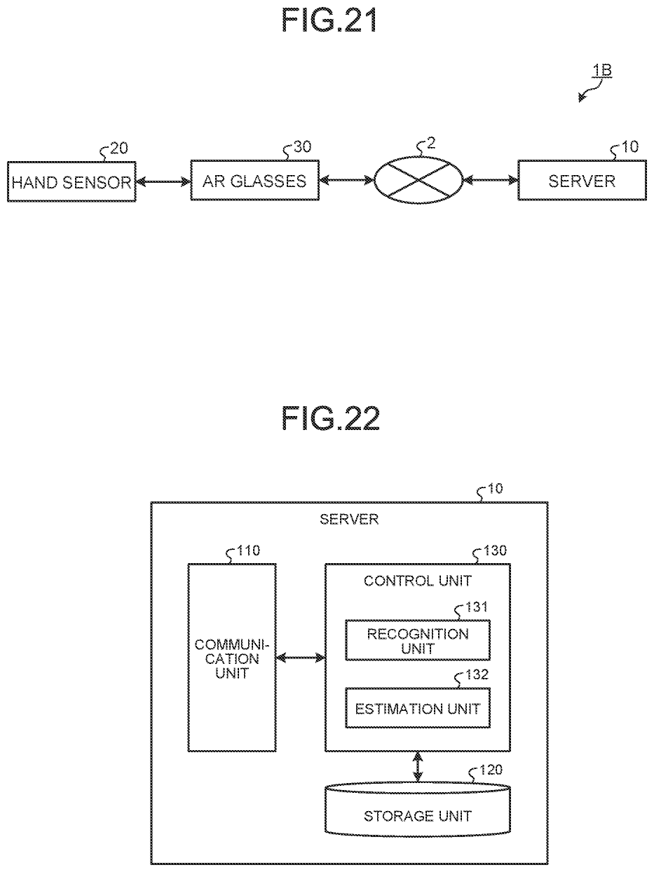

In the above-described embodiment, it has been described as an example that the AR glasses 30 included in the AR glasses system 1A have an object recognition function and a position estimation function. However, the present disclosure is not particularly limited to this example. For example, the object recognition function and the position estimation function of the AR glasses 30 may be decentralized to an external server device. Hereinafter, an example of a configuration of an AR glasses system 1B according to a modification will be described. FIG. 21 is a diagram illustrating an example of a configuration of an AR glasses system according to a modification. FIG. 22 is a block diagram illustrating an example of a functional configuration of a server device according to a modification.

As illustrated in FIG. 21, the AR glasses system 1B according to the modification includes a server device 10, a hand sensor 20, and AR glasses 30. The AR glasses system 1B is different from the AR glasses system 1A described above in that the server device 10 is included. Note that the number of components of the AR glasses system 1B illustrated in FIG. 21 is an example, and the AR glasses system 1B may include more server devices 10, more hand sensors 20, and more AR glasses 30 than that in the example illustrated in FIG. 21.

The server device 10 and the AR glasses 30 are connected to a network 2. The server device 10 and the AR glasses 30 can communicate with each other through the network 2. The AR glasses 30 upload data such as a camera image to the server device 10. In addition, the AR glasses 30 download and use recognition object information and the like accumulated in the server device 10.

As illustrated in FIG. 22, the server device 10 includes a communication unit 110, a storage unit 120, and a control unit 130.

The communication unit 110 communicates with the AR glasses 30 via the network 2. The communication unit 110 transmits and receives data related to processing of the AR glasses system 1B.

The storage unit 120 stores programs, data, and the like for implementing various processing functions to be executed by the control unit 130. The storage unit 120 stores camera image data received by the control unit 130 from the AR glasses 30 through the network 2, recognition object information obtained by the control unit 130 analyzing the camera image, and the like.

The control unit 130 is, for example, a controller. The processing functions provided by the control unit 130 are implemented by a processor or the like executing a program stored in the server device 10 using a main storage device or the like as a work area.

As illustrated in FIG. 22, the control unit 130 includes a recognition unit 131 and an estimation unit 132.

The recognition unit 131 provides a processing function similar to that of the object recognition unit 351 included in the AR glasses 30 of the AR glasses system 1A. The recognition unit 131 analyzes the camera image uploaded from the AR glasses 30, and records recognition object information detected from the camera image in the storage unit 120.

The estimation unit 132 provides a processing function similar to that of the position estimation unit 352 included in the AR glasses 30 of the AR glasses system 1A. The estimation unit 132 estimates a position of a recognition object on the basis of an RGB image and a distance image acquired from the AR glasses 30. The estimation unit 132 records the position information for the recognition object in the storage unit 120 in association with the recognition object information detected by the recognition unit 131.

The AR glasses 30 included in the AR glasses system 1B may not have functions decentralized to the server device 10 (the object recognition unit 351 and the position estimation unit 352).

By decentralizing some of the processing functions of the AR glasses 30 to the server device 10 as described above, a processing load of the AR glasses 30 can be reduced. Furthermore, in the server device 10, by sharing the information uploaded from the plurality of AR glasses 30, it is also possible to expect an effect in improving the processing efficiency of the AR glasses 30.

<5-5. Other Modifications>

The AR glasses system 1 (1A or 1B) according to the embodiment of the present disclosure or the modification thereof may be realized by a dedicated computer system or a general-purpose computer system.

In addition, the various programs for the AR glasses 30 to implement the information processing method according to the embodiment of the present disclosure or the modification thereof may be distributed after being stored in a computer-readable recording medium such as an optical disk, a semiconductor memory, a magnetic tape, or a flexible disk. At this time, for example, the AR glasses 30 implements the information processing method according to the embodiment of the present disclosure or the modification thereof by installing and executing the various programs in the computer.

In addition, the various programs for the AR glasses 30 to implement the information processing method according to the embodiment of the present disclosure or the modification thereof may be downloaded to the computer after being stored in a disk device included in a server device on a network such as the Internet. In addition, the functions provided by the various programs for implementing the information processing method according to the embodiment of the present disclosure or the modification thereof may be implemented by the OS and the application program in cooperation with each other. In this case, parts other than the OS may be distributed after being stored in the medium, or parts other than the OS may be downloaded to the computer after being stored in the server device.

In addition, among the processes described in the embodiment of the present disclosure and the modifications thereof, all or some of the processes described as being automatically performed can be manually performed, or all or some of the processes described as being manually performed can be automatically performed by known methods. In addition, the processing procedures, the specific terms, and the information including various kinds of data and parameters described in the above documents and drawings can be arbitrarily changed unless otherwise specified. For example, the various kinds of information illustrated in each of the drawings are not limited to the illustrated information.

In addition, each component of the AR glasses 30 according to the embodiment of the present disclosure (see FIG. 4) is functionally conceptual, and is not necessarily configured as illustrated in the drawings in physical term. That is, a specific form in which the devices are distributed or integrated is not limited to what is illustrated, and all or some of the devices can be configured to be functionally or physically distributed or integrated in an arbitrary unit according to various loads, usage conditions, and the like.

In addition, the embodiments of the present invention can be appropriately combined unless any processing contradiction is caused. In addition, the order of the steps illustrated in the flowchart according to the embodiment of the present disclosure can be changed if appropriate.

### 6. Example of Hardware Configuration

<6-1. Concerning Hand Sensor>

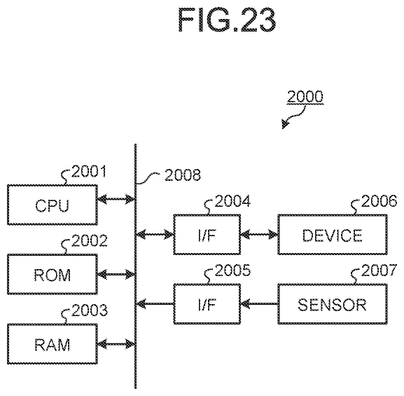

An example of a hardware configuration of the hand sensor applicable to the embodiment of the present disclosure and the modifications thereof will be described with reference to FIG. 23. FIG. 23 is a block diagram illustrating an example of a hardware configuration of the hand sensor.

As illustrated in FIG. 23, a device 2000 corresponding to the hand sensor 20 includes a CPU 2001, a read only memory (ROM) 2002, a RAM 2003, an interface (I/F) 2004, an interface (I/F) 2005, a communication device 2006, and a sensor 2007. The CPU 2001, the ROM 2002, the RAM 2003, the interface (I/F) 2004, and the interface (I/F) 2005 are connected to each other via a bus 2008.

The ROM 2002 stores programs and data for operating the device 2000. The RAM 2003 functions as a work memory that temporarily stores data when the CPU 2001 executes the programs.

The interface (I/F) 2004, which is a communication interface for the communication device 2006, controls communication with the AR glasses 30 according to a command of the CPU 2001. The interface (I/F) 2005, which is a sensor interface for the sensor 2007, supplies a sensor signal transmitted from the sensor 2007 to the CPU 2001.

The communication device 2006 executes communication with the AR glasses. The communication device 2006 transmits a sensor signal detected by the sensor 2007 to the AR glasses 30. The sensor 2007 detects a position, a posture, and the like of the device 2000. The sensor 2007 supplies the detected sensor signal to the CPU 2001. The sensor 2007 corresponds to the acceleration sensor 210, the gyro sensor 220, the azimuth sensor 230, and the distance measurement sensor 240.

The CPU 2001 transmits the sensor signal acquired from the sensor 2007 via the interface (I/F) 2005 to the communication device 2006 via the interface (I/F) 2004.

<6-2. Concerning AR Glasses>

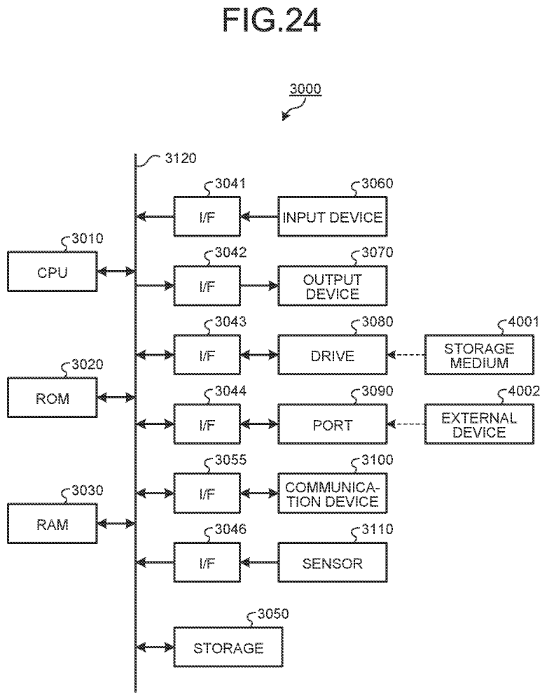

An example of a hardware configuration of the AR glasses applicable to the embodiment of the present disclosure and the modifications thereof will be described with reference to FIG. 24. FIG. 24 is a block diagram illustrating an example of a hardware configuration of the AR glasses.

As illustrated in FIG. 24, an information processing apparatus 3000 corresponding to the AR glasses 30 includes a CPU 3010, a ROM 3020, a RAM 3030, interfaces (I/Fs) 3041 to 3046, a storage 3050, an input device 3060, an output device 3070, a drive 3080, a port 3090, a communication device 3100, and a sensor 3110. A display control unit 1506, an audio I/F 1507, and a communication I/F 1508 are included. The units included in the information processing apparatus 3000 are connected to each other by a bus 3120.

The CPU 3010 functions as, for example, an arithmetic processing device or a control device, and controls all or some of the operations of the components on the basis of various programs recorded in the ROM 3020. The various programs stored in the ROM 3020 may be recorded in the storage 3050 or a recording medium 4001 connected via the drive 3080. In this case, the CPU 3010 controls all or some of the operations of the components on the basis of the programs stored in the recording medium 4001. The various programs include programs for providing various functions for implementing the information processing of the information processing apparatus 3000.

The ROM 3020 functions as an auxiliary storage device that stores programs read by the CPU 3010, data used for calculation, and the like. The RAM 3030 functions as a main storage device that temporarily or permanently stores, for example, programs read by the CPU 3010 and various parameters and the like that appropriately switch to execute the programs read by the CPU 3010.

The CPU 3010, the ROM 3020, and the RAM 3030 can implement various functions of the units (the object recognition unit 351 to the output control unit 359) provided in the control unit 350 of the AR glasses 30 described above in cooperation with software (the various programs stored in the ROM 3020 and the like). The CPU 3010 executes various programs and performs arithmetic processing and the like using data acquired via the interfaces (I/Fs) 3041 to 3046 to execute the processing of the AR glasses 30.

The interface (IF) 3041 is, for example, an input interface for the input device 3060. The interface (IF) 3042 is, for example, an output interface for the output device 3070. The interface (IF) 3043 includes, for example, a drive interface for the drive 3080. The interface (IF) 3044 is, for example, a port interface for the port 3090. The interface (IF) 3045 is, for example, a communication interface for the communication device 3100. The interface (IF) 3046 is, for example, a sensor interface for the sensor 3110.

The storage 3050 is a device for storing various types of data, and for example, a magnetic storage device such as a hard disk drive (HDD), a semiconductor storage device, an optical storage device, a magneto-optical storage device, or the like is used. The function of the storage unit 340 of the AR glasses described above can be implemented by the storage 3050.

The input device 3060 is realized by, for example, a device to which information is input by a user, such as a touch panel, a button, a switch, or a lever. The input device 3060 may be a remote controller capable of transmitting a control signal using infrared rays or other radio waves. Also, the input device 3060 may include a sound input device such as a microphone. The interface (IF) 3041 includes an interface corresponding to processing of various signals input through the input device 3060.

The output device 3070 is a device capable of visually or audibly notifying a user of acquired information, such as a display device or an audio output device, e.g., a speaker or a headphone. The display unit 331 and the sound output unit 332 of the AR glasses 30 described above can be realized by the output device 3070. The interface (IF) 3041 includes an interface corresponding to processing of various signals that can be handled by the output device 3070.

The drive 3080 is, for example, a device that reads information recorded in the recording medium 4001 and writes information into the recording medium 4001. The recording medium 4001 includes a magnetic disk, an optical disk, a magneto-optical disk, a semiconductor memory, or the like.

The port 3090, which is a connection port for connecting an external device 4002, includes a universal serial bus (USB) port, an IEEE1394 port, a small computer system interface (SCSI), an RS-232C port, an optical audio terminal, or the like. Note that the external device 4002 includes a printer, a portable music player, a digital camera, a digital video camera, an IC recorder, or the like.

The communication device 3100 is a communication device that performs communication with the server device 10 and the hand sensor 20. The communication device 3100 is, for example, a communication card for wired or wireless local area network (LAN), long term evolution (LTE), Bluetooth (registered trademark), wireless USB (WUSB), or the like. Furthermore, the communication device 3100 may be a router for optical communication, various communication modems, or the like. The function of the communication unit 320 of the AR glasses 30 described above can be implemented by the communication device 3100.

The sensor 3110, which includes various sensors, corresponds to the camera 311, the acceleration sensor 312, the gyro sensor 313, the azimuth sensor 314, the microphone 315, and the like included in the AR glasses described above. The interface (IF) 3046 includes an interface corresponding to processing of sensor signals supplied from the various sensors.

### 7. Conclusion

An AR glasses 30 (an example of an information processing apparatus) according to an embodiment of the present disclosure include a display unit 331 and a control unit 350. The display unit 331 displays a virtual operation object, which is a virtual object to be operated, to be superimposed on a reality space visually recognized by a user. The control unit 350 determines a superimposition target object on which the virtual operation object is to be superimposed from among a plurality of objects existing around the user in the reality space, detects a movement of a hand of the user in a state where the virtual operation object is displayed, and presents the virtual operation object to the user while moving the virtual operation object to approach the superimposition target object in conjunction with the detected movement of the hand of the user.

Therefore, the AR glasses 30 can guide the user by moving the virtual operation object in conjunction with the movement of the hand of the user. As a result, the AR glasses 30 can improve usability during operating a virtual object in the AR technology.

In addition, the AR glasses 30 move the operation object on the basis of a projection position of the hand of the user, at which a position of the hand of the user is projected onto a plane defining a display area of the display unit 331, and a display position of the virtual operation object in the display area. As a result, the AR glasses 30 can determine a positional relationship between the hand of the user and the virtual operation object with simple processing.

In addition, the AR glasses 30 move the operation object in such a manner that the projection position of the hand of the user and the display position of the virtual operation object do not overlap each other. As a result, the AR glasses 30 can enable the user to reliably recognize the operation object.

In addition, the AR glasses 30 move the operation object along a line connecting the projection position of the hand of the user to a projection position of the superimposition target object, at which a position of the superimposition target object is projected onto the plane defining the display area of the display unit 331, in such a manner that the display position of the virtual operation object precedes the projection position of the hand of the user. As a result, the AR glasses 30 can guide the hand of the user to follow the operation object.

In addition, the AR glasses 30 move the virtual operation object until the virtual operation object reaches the projection position of the superimposition target object. As a result, the AR glasses 30 can enable the user to easily grip the superimposition target object.

In addition, after moving the virtual operation object until the virtual operation object reaches the projection position of the superimposition target object, the AR glasses 30 present, to the user, the operation object superimposed on the superimposition target object. As a result, the AR glasses 30 can urge the user to operate the operation object subsequently to a series of processes for guiding the user to the superimposition target object. In addition, when the operation object is operated, an appropriate reaction force is given to the user from the superimposition target object, and as a result, a real operational feeling can be realized.

In addition, the AR glasses 30 acquire geometric information for the superimposition target object, and determine a layout of the virtual operation object on the basis of the acquired geometric information. As a result, the AR glasses 30 can prevent a positional deviation between the superimposition target object and the virtual operation object.

In addition, the AR glasses 30 acquire disassembility information for a sensor worn on the hand of the user, and determine the layout of the virtual operation object on the basis of the acquired disassembility information. As a result, the AR glasses 30 can provide the user with the operation object having a layout that matches the ability of the hand sensor 20.

In addition, the AR glasses 30 determine the superimposition target object from among a plurality of recognition objects detected from a camera image obtained by imaging surroundings of the user. As a result, the AR glasses 30 can produce a sense of immersion in the expanded space.

In addition, the AR glasses 30 calculate a distance between each of the recognition objects and the hand of the user on the basis of a three-dimensional position of each of the plurality of recognition objects and a three-dimensional position of the hand of the user. In addition, the AR glasses 30 calculate an inner product value between a vector connecting the three-dimensional position of each of the plurality of recognition objects and the three-dimensional position of the hand of the user to each other and a normal vector defining a plane including a palm of the user for each of the plurality of recognition objects. In addition, the AR glasses 30 determine the superimposition target object from among the plurality of recognition objects on the basis of the distance and the inner product value. As a result, the AR glasses 30 can superimpose the virtual operation object on an object that is highly likely to be gripped by the user.

In addition, the AR glasses 30 exclude an object that is not suitable for the user to grip from superimposition target object candidates on the basis of a result of recognizing the plurality of objects. As a result, the AR glasses 30 can avoid superimposing the virtual operation object on an object that not suitable for operation, such as a glass containing liquid.

In addition, the AR glasses 30 determine the superimposition target object on the basis of a characteristic of the user. As a result, the AR glasses 30 can superimpose the virtual operation object on an object matching the characteristic of the user.

In addition, the AR glasses 30 determine the superimposition target object on the basis of information regarding a physical handicap of the user. As a result, the AR glasses 30 can superimpose the virtual operation object on an object that is not inconvenient for the user.

In addition, the AR glasses 30 determine the superimposition target object on the basis of information of a dominant hand of the user. As a result, the AR glasses 30 can superimpose the virtual operation object on an object placed at a position for the user to easily grip.

In addition, the AR glasses 30 determine the superimposition target object on the basis of an action of the user. As a result, the AR glasses 30 can superimpose the virtual operation object on an object placed at a position matching the action of the user, for example, by determining an object in front of the user as a superimposition target object when the user is walking.

Furthermore, the AR glasses 30 determine the movement of the hand of the user as an operation start action of the user using the operation object on the basis of a distance between a projection position of the hand of the user, at which a position of the hand of the user is projected onto a plane defining a display area of the display unit 331, and a display position of the operation object in the display area. As a result, the AR glasses 30 can operate flexibly according to a request of the user.

In addition, when a predetermined period of time has elapsed in a state where the distance between the projection position of the hand of the user and the display position of the virtual operation object is equal to or smaller than a predetermined threshold value, the AR glasses 30 determine the movement of the hand of the user as an operation start action. As a result, the AR glasses 30 can improve accuracy in determining an intention of the user to use the operation object.

In addition, the AR glasses 30 track positions of a plurality of recognition objects detected from a camera image obtained by imaging surroundings of the user to determine whether or not each of the plurality of recognition objects is grippable. As a result, the AR glasses 30 can select an object to be a superimposition target object candidate without performing complicated processing.

In addition, the AR glasses 30 assign mark information to an object determined to be grippable. As a result, the AR glasses 30 can improve accuracy in recognizing an object once it is determined to be grippable.

Although the embodiment of the present disclosure and modifications thereof have been described above, the technical scope of the present disclosure is not limited to the above-described embodiment and modifications, and various modifications can be made without departing from the gist of the present disclosure. In addition, components of the different embodiment and modifications may be appropriately combined.

Furthermore, the effects described in the present specification are merely illustrative or exemplary, and are not restrictive. That is, the technology according to the present disclosure can exhibit other effects obvious to those skilled in the art from the description of the present specification together with or instead of the above effects.

Note that the technology according to the present disclosure can also have the following configurations, which also fall within the technical scope of the present disclosure.

(1)

An information processing apparatus comprising:

a display unit that displays a virtual operation object to be superimposed on a reality space visually recognized by a user; and

a control unit that determines a superimposition target object on which the operation object is to be superimposed from among a plurality of objects existing around the user in the reality space, detects a movement of a hand of the user in a state where the operation object is displayed, and presents the operation object to the user while moving the operation object to approach the superimposition target object in conjunction with the detected movement of the hand of the user.

(2)

The information processing apparatus according to (1), wherein

the control unit

moves the operation object on the basis of a projection position of the hand of the user, at which a position of the hand of the user is projected onto a plane defining a display area of the display unit, and a display position of the operation object in the display area.

(3)

The information processing apparatus according to (2), wherein

the control unit

moves the operation object in such a manner that the projection position of the hand of the user and the display position of the operation object do not overlap each other.

(4)

The information processing apparatus according to (2) or (3), wherein

the control unit

moves the operation object along a line connecting the projection position of the hand of the user to a projection position of the superimposition target object, at which a position of the superimposition target object is projected onto the plane, in such a manner that the display position of the operation object precedes the projection position of the hand of the user.

(5)

The information processing apparatus according to (4), wherein

the control unit

moves the operation object until the operation object reaches the projection position of the superimposition target object.

(6)

The information processing apparatus according to (5), wherein

after moving the operation object until the operation object reaches the projection position of the superimposition target object, the control unit

presents, to the user, the operation object superimposed on the superimposition target object.

(7)

The information processing apparatus according to any one of (1) to (6), wherein

the control unit

acquires geometric information for the superimposition target object, and determines a layout of the operation object on the basis of the acquired geometric information.

(8)

The information processing apparatus according to (7), wherein

the control unit

acquires disassembility information for a sensor worn on the hand of the user, and

determines the layout of the operation object on the basis of the acquired disassembility information.

(9)

The information processing apparatus according to any one of (1) to (8), wherein

the control unit

determines the superimposition target object from among a plurality of recognition objects detected from a camera image obtained by imaging surroundings of the user.

(10)

The information processing apparatus according to (9), wherein

the control unit

calculates a distance between each of the recognition objects and the hand of the user on the basis of a three-dimensional position of each of the plurality of recognition objects and a three-dimensional position of the hand of the user,

calculates, for each of the plurality of recognition objects, an inner product value between a vector connecting the three-dimensional position of each of the plurality of recognition objects and the three-dimensional position of the hand of the user to each other and a normal vector defining a plane including a palm of the user, and

determines the superimposition target object from among the plurality of recognition objects on the basis of the distance and the inner product value.

(11)

The information processing apparatus according to any one of (1) to (10), wherein

the control unit

excludes an object that is not suitable for the user to grip from superimposition target object candidates on the basis of a result of recognizing the plurality of objects.

(12)

The information processing apparatus according to any one of (1) to (11), wherein

the control unit

determines the superimposition target object on the basis of a characteristic of the user.

(13)

The information processing apparatus according to (12), wherein

the control unit

determines the superimposition target object on the basis of information regarding a physical handicap of the user.

(14)

The information processing apparatus according to (12), wherein

the control unit

determines the superimposition target object on the basis of information regarding a dominant hand of the user.

(15)

The information processing apparatus according to (1), wherein

the control unit

determines the movement of the hand of the user as an operation start action of the user using the operation object on the basis of a distance between a projection position of the hand of the user, at which a position of the hand of the user is projected onto a plane defining a display area of the display unit, and a display position of the operation object in the display area.

(16)

The information processing apparatus according to (15), wherein

when a predetermined period of time has elapsed in a state where the distance between the projection position of the hand of the user and the display position of the operation object is equal to or smaller than a predetermined threshold value, the control unit

determines the movement of the hand of the user as the operation start action.

(17)

The information processing apparatus according to (1), wherein

the control unit

tracks positions of a plurality of recognition objects detected from a camera image obtained by imaging surroundings of the user to determine whether or not each of the plurality of recognition objects is grippable.

(18)

The information processing apparatus according to (17), wherein

the control unit

assigns mark information to an object determined to be grippable.

(19)

An information processing method performed by a processor, the information processing method comprising:

displaying a virtual operation object to be superimposed on a reality space visually recognized by a user;

determining a superimposition target object on which the operation object is to be superimposed from among a plurality of objects existing around the user in the reality space;

detecting a movement of a hand of the user in a state where the operation object is displayed; and

presenting the operation object to the user while moving the operation object to approach the superimposition target object in conjunction with the detected movement of the hand of the user.

(20)

An information processing program for causing a processor to perform:

displaying a virtual operation object to be superimposed on a reality space visually recognized by a user;

determining a superimposition target object on which the operation object is to be superimposed from among a plurality of objects existing around the user in the reality space;

detecting a movement of a hand of the user in a state where the operation object is displayed; and

presenting the operation object to the user while moving the operation object to approach the superimposition target object in conjunction with the detected movement of the hand of the user.

### REFERENCE SIGNS LIST

1(1A, 1B) AR GLASSES SYSTEM
2 NETWORK
10 SERVER DEVICE
20 HAND SENSOR
30 AR GLASSES
110 COMMUNICATION UNIT
120 STORAGE UNIT
130 CONTROL UNIT
131 RECOGNITION UNIT
132 ESTIMATION UNIT
210 ACCELERATION SENSOR
220 GYRO SENSOR
230 AZIMUTH SENSOR
240 DISTANCE MEASUREMENT SENSOR
310 SENSOR UNIT
311 CAMERA
312 ACCELERATION SENSOR
313 GYRO SENSOR
314 AZIMUTH SENSOR
315 MICROPHONE
320 COMMUNICATION UNIT
330 OUTPUT UNIT
331 DISPLAY UNIT
332 SOUND OUTPUT UNIT
340 STORAGE UNIT
341 GRIPPABILITY DETERMINATION INFORMATION STORAGE UNIT
342 SUPERIMPOSITION DETERMINATION INFORMATION STORAGE UNIT
350 CONTROL UNIT
351 OBJECT RECOGNITION UNIT
352 POSITION ESTIMATION UNIT
353 GRIPPABILITY DETERMINATION UNIT
354 OPERATION START ACTION DETERMINATION UNIT
355 SUPERIMPOSITION TARGET OBJECT DETERMINATION UNIT
356 VIRTUAL OPERATION OBJECT LAYOUT DETERMINATION UNIT
357 MOVEMENT START POSITION DETERMINATION UNIT
358 APPLICATION EXECUTION UNIT
359 OUTPUT CONTROL UNIT

1. An information processing apparatus comprising:
a display unit that displays a virtual operation object to be superimposed on a reality space visually recognized by a user; and
a control unit that determines a superimposition target object on which the operation object is to be superimposed from among a plurality of objects existing around the user in the reality space, detects a movement of a hand of the user in a state where the operation object is displayed, and presents the operation object to the user while moving the operation object to approach the superimposition target object in conjunction with the detected movement of the hand of the user.

2. The information processing apparatus according to claim 1, wherein
the control unit
moves the operation object on the basis of a projection position of the hand of the user, at which a position of the hand of the user is projected onto a plane defining a display area of the display unit, and a display position of the operation object in the display area.

3. The information processing apparatus according to claim 2, wherein
the control unit
moves the operation object in such a manner that the projection position of the hand of the user and the display position of the operation object do not overlap each other.

4. The information processing apparatus according to claim 3, wherein
the control unit
moves the operation object along a line connecting the projection position of the hand of the user to a projection position of the superimposition target object, at which a position of the superimposition target object is projected onto the plane, in such a manner that the display position of the operation object precedes the projection position of the hand of the user.

5. The information processing apparatus according to claim 4, wherein
the control unit
moves the operation object until the operation object reaches the projection position of the superimposition target object.

6. The information processing apparatus according to claim 5, wherein
after moving the operation object until the operation object reaches the projection position of the superimposition target object, the control unit
presents, to the user, the operation object superimposed on the superimposition target object.

7. The information processing apparatus according to claim 1, wherein
the control unit
acquires geometric information for the superimposition target object, and determines a layout of the operation object on the basis of the acquired geometric information.

8. The information processing apparatus according to claim 7, wherein
the control unit
acquires disassembility information for a sensor worn on the hand of the user, and
determines the layout of the operation object on the basis of the acquired disassembility information.

9. The information processing apparatus according to claim 1, wherein
the control unit
determines the superimposition target object from among a plurality of recognition objects detected from a camera image obtained by imaging surroundings of the user.

10. The information processing apparatus according to claim 9, wherein
the control unit
calculates a distance between each of the recognition objects and the hand of the user on the basis of a three-dimensional position of each of the plurality of recognition objects and a three-dimensional position of the hand of the user,
calculates, for each of the plurality of recognition objects, an inner product value between a vector connecting the three-dimensional position of each of the plurality of recognition objects and the three-dimensional position of the hand of the user to each other and a normal vector defining a plane including a palm of the user, and
determines the superimposition target object from among the plurality of recognition objects on the basis of the distance and the inner product value.

11. The information processing apparatus according to claim 1, wherein
the control unit
excludes an object that is not suitable for the user to grip from superimposition target object candidates on the basis of a result of recognizing the plurality of objects.

12. The information processing apparatus according to claim 1, wherein
the control unit
determines the superimposition target object on the basis of a characteristic of the user.

13. The information processing apparatus according to claim 12, wherein
the control unit
determines the superimposition target object on the basis of information regarding a physical handicap of the user.

14. The information processing apparatus according to claim 12, wherein
the control unit
determines the superimposition target object on the basis of information regarding a dominant hand of the user.

15. The information processing apparatus according to claim 1, wherein
the control unit
determines the movement of the hand of the user as an operation start action of the user using the operation object on the basis of a distance between a projection position of the hand of the user, at which a position of the hand of the user is projected onto a plane defining a display area of the display unit, and a display position of the operation object in the display area.

16. The information processing apparatus according to claim 15, wherein
when a predetermined period of time has elapsed in a state where the distance between the projection position of the hand of the user and the display position of the operation object is equal to or smaller than a predetermined threshold value, the control unit
determines the movement of the hand of the user as the operation start action.

17. The information processing apparatus according to claim 1, wherein
the control unit
tracks positions of a plurality of recognition objects detected from a camera image obtained by imaging surroundings of the user to determine whether or not each of the plurality of recognition objects is grippable.

18. The information processing apparatus according to claim 17, wherein
the control unit
assigns mark information to an object determined to be grippable.

19. An information processing method performed by a processor, the information processing method comprising:
displaying a virtual operation object to be superimposed on a reality space visually recognized by a user;
determining a superimposition target object on which the operation object is to be superimposed from among a plurality of objects existing around the user in the reality space;
detecting a movement of a hand of the user in a state where the operation object is displayed; and
presenting the operation object to the user while moving the operation object to approach the superimposition target object in conjunction with the detected movement of the hand of the user.

20. An information processing program for causing a processor to perform:
displaying a virtual operation object to be superimposed on a reality space visually recognized by a user;
determining a superimposition target object on which the operation object is to be superimposed from among a plurality of objects existing around the user in the reality space;
detecting a movement of a hand of the user in a state where the operation object is displayed; and
presenting the operation object to the user while moving the operation object to approach the superimposition target object in conjunction with the detected movement of the hand of the user.
